(19) United States
(12) Patent Application Publication
(10) Pub. No.: US 2025/0211558 A1
(43) Pub. Date: Jun. 26, 2025

(54) Systems And Methods For Building A Message Record And Managing Communications Relating To Real Estate Transactions

(71) Applicant: Eric L. Pankey, Duluth, GA (US)

(72) Inventor: Eric L. Pankey, Duluth, GA (US)

(21) Appl. No.: 18/974,695

(22) Filed: Dec. 9, 2024

Related U.S. Application Data
(60) Provisional application No. 63/608,209, filed on Dec. 9, 2023.

(51) Int. Cl. H04L 51/216; G06Q 50/16; H04L 67/306

(52) U.S. Cl. CPC H04L 51/216; G06Q 50/16; H04L 67/306

(57) ABSTRACT

Systems and methods for building message records and managing communications relating to real estate transactions are provided. System architecture and integration, customizable message creation, dynamic message retrieval, client type and property information, and market trends and client specialty values are used to provide efficient communication management, personalized client engagement, real-time updates and responsiveness, comprehensive information delivery, and adaptability to client specifics to facilitate real estate transactions.

### CROSS REFERENCE TO RELATED APPLICATIONS

This application claims the benefit of U.S. Provisional Application Ser. No. 63/608,225, filed on Dec. 9, 2023, which is hereby incorporated by reference herein in its entirety.

### FIELD OF THE INVENTION

The invention relates to real estate transaction management and systems and methods for providing such.

### BACKGROUND OF THE INVENTION

In today's rapidly progressing digital era, the real estate sector faces unique challenges. The heart of real estate has always been the personal touch, the human connection, and the irreplaceable wisdom that seasoned professionals bring to the table. Yet, the real estate sector does not seamlessly intertwine the systems and methods of technological advancements with the core values from the personal touch, the human connection, and expert and personalized service. Specific problems with current platforms, systems and methods include information overload of the clients and others, lack of personalization to particular clients, lack of agent alignment with the others in their group, poor drivers for agent performance and services, poor integration of diverse services, poor and delayed feedback mechanisms, lack of client trust, overwhelming volumes of data, unreliable independent sources of advice, and the failure to empower agents with timely information and training. Thus, there is a need to invent technically advanced systems and methods to facilitate real estate transactions, including providing for a personal touch, human connection, and expert and personalized services in the real estate sector.

In particular, certain of the most significant problems have not been adequately addressed, including a lack of anonymity, a lack of a personalized, useful and accurate experience, and the lack of efficient, seamless transitions, which led to failures in the process. There is a need to address these significant problems, among others.

### SUMMARY OF THE INVENTION

This invention relates to new platforms (comprised of systems and methods), systems and methods that facilitate real estate transactions, including by providing a personal touch, human connection, and expert and personalized services in the real estate sector. Aspects of this invention include embodiments that provide platforms, systems and methods for building a message record and managing communications relating to real estate transactions.

This invention can provide a comprehensive approach to managing communications within the framework of real estate transactions. Embodiments of this invention address the complexities and needs of modern real estate transactions, focusing on creating, storing, and strategically retrieving message records. The solutions applied by these embodiments are multifaceted, addressing several key challenges, as illustrated by the following technical intricacies and solutions:

### 1. Technical Intricacies

System Architecture and Integration: Certain embodiments of this invention involve a sophisticated system architecture comprising a system application server, a system session server, a user profile database, and a message database. This integrated approach ensures seamless communication and data flow between different components, vital for handling complex data in real estate transactions.

Customizable Message Creation: The message creation interface allows for tailored message inputs, including identifiers, titles, client types, and more in preferred embodiments. This level of customization is critical in real estate where varying client needs and transaction stages require personalized communication strategies.

Dynamic Message Retrieval: Certain embodiments have the capability to retrieve messages based on updates in the client's profile is particularly noteworthy. It allows for real-time communication adjustments as the transaction progresses through different stages, ensuring that all parties receive relevant and timely information.

Client Type and Property Information: Certain embodiments accommodate different client types (buyer or seller) and include detailed property information. This feature ensures that messages are not just transaction stage-appropriate but also client-specific, enhancing the relevance and effectiveness of communication.

Market Trends and Client Specialty Values: Inclusion of market rating values, trend information, and client specialty values in certain embodiments in the messaging strategy is a significant advancement. It provides clients and agents with insights into market dynamics and specific client needs, enhancing decision-making processes.

### 2. Problem-Solving Aspects

Efficient Communication Management: Preferred embodiments streamline the communication process in real estate transactions, addressing the challenge of managing multiple, often fragmented, information streams.

Personalized Client Engagement: By customizing messages based on client types and transaction stages, preferred embodiments ensure personalized engagement, addressing the unique needs and concerns of each client.

Real-Time Updates and Responsiveness: The ability to update and retrieve messages in response to transaction progress in certain embodiments solves the problem of delayed or irrelevant communication, fostering timely and effective decision-making.

Comprehensive Information Delivery: Incorporating a wide range of information, from property details to market trends, preferred embodiments ensure comprehensive communication, addressing the need for informed decision-making in real estate transactions.

Adaptability to Client Specifics: By considering client specifics like mortgage status or client specialty values, certain embodiments cater to diverse client portfolios, enhancing the quality of service provided.

In particular, certain embodiments of this invention provide anonymity, personalized and more useful and accurate experiences, and/or seamless transitions, which solutions to significant problems were absent in the past. Therefore, embodiments of this invention solve technical problems of the past that arise from a lack of anonymity, lack of personalized, useful and accurate experiences, and from complex and unsuccessful transitions that led to incomplete and failed processes.

Preferred embodiments offer a sophisticated solution to the challenges of communication management in real estate transactions. They demonstrate a deep understanding of the sector's intricacies, providing a tool that not only facilitates efficient communication but also enhances client engagement and decision-making processes.

Certain preferred embodiments of this invention provide methods for creating, storing and retrieving a message record configured to be distributed to a client and an agent of the client over a course of a real estate transaction of the client. These methods comprise at least some of the following, such as: (a) providing a system application server including a memory for storing processor instructions and a processor for executing the processor instructions; (b) providing a system session server, in communication with the system application server, the system session server configured to establish and maintain a system session with and generate a message creation interface accessible by a message creator; (c) providing a user profile database, in communication with the system application server, the user profile database including a client profile record of the client (e.g., contact information and/or open-access engagement tools (e.g., user input preferences, such as budget, location, property type, etc., instead of contact information; an anonymized data tracking code)); (d) providing a message database in communication with the system application server, the message database configured to store and retrieve a plurality of stored message records; (e) receiving message creator input via the message creation interface, the message creator input including: a message identifier, a message title, a client type value, at least one state value, at least one step of a plurality of progressive steps in a real estate transaction of the client, message core data, a message topic description, a target message destination section configured to be displayed on at least one user interface having a plurality of message destination sections, a client agent specific message configured to be displayed on a client agent user interface in a client agent specific message section, a message expiration date, a message specific sort order number value configured to enable sorting of a plurality of message records according to each message specific sort order number, property information regarding the real estate transaction, at least one additional client solicited service information, a current market rating value, a current market trend value, a client specialty value, and a message record update date and timestamp value; (f) storing the message creator input in a message record within the message database; and (g) retrieving the message record from the message database based on a user profile record update in response to a change in a step value of the plurality of progressive steps in the real estate transaction of the client in the client profile record and matching at least one message creator input value to at least one data field in the client profile record.

In some embodiments of these methods, the client type value is a client buyer value.

In some embodiments of these methods, the method further comprising inputting, via the message creation interface, a client buyer mortgage status value.

In some embodiments of these methods, the client buyer mortgage status value includes one of a cash buyer status value, a pre-approved status value, a pre-qualified status value, an awaiting status value, and a not applied status value.

In some embodiments of these methods, the client type value is a client seller value.

In some embodiments of these methods, the at least one step includes one of first step, a second step, a third step, a fourth step and a fifth step in the real estate transaction of the client.

In some embodiments of these methods, the first step is configured to notify the client of a status of an initial client information intake process in the real estate transaction.

In some embodiments of these methods, the second step is configured to notify the client of a status of completion of an initial client information intake process and an initiation of a client agent matching step in the real estate transaction.

In some embodiments of these methods, the third step is configured to notify the client of a status of completion of a client agent matching process and prompt the client for input regarding a proposed client agent.

In some embodiments of these methods, the fourth step is configured to solicit client input regarding a proposed client agent and notify the client of a client agent match status.

In some embodiments of these methods, the fifth step is configured to notify the client of a particular stage value of a plurality of stages in the real estate transaction.

In some embodiments of these methods, the particular stage value of the plurality of stages in the real estate transaction includes at least one of an offer submitted value, a backup offer submitted value, an offer rejected value, an offer rejection value, a counteroffer submitted value, a counteroffer received value, and an accepted offer value.

In some embodiments of these methods, message core data includes text information.

In some embodiments of these methods, message core data includes a predetermined document having a preconfigured format.

In some embodiments of these methods, the at least one user interface includes a client user interface of the client in the real estate transaction.

In some embodiments of these methods, the at least one user interface includes a client agent user interface of a client agent assisting the client in the real estate transaction.

In some embodiments of these methods, the at least one user interface includes a client user interface of the client in the real estate transaction and a client agent user interface of a client agent assisting the client in the real estate transaction.

In some embodiments of these methods, property information includes a property type value including one of a single-family property type, a townhouse property type, a condominium property type, a foreclosure property type, a short sale property type, a probate property type, a bankruptcy property type.

In some embodiments of these methods, property information includes a price tier value including one of an affordable price tier value, a moderate price tier value, and a luxury price tier value.

In some embodiments of these methods, the at least one additional client solicited service information includes at least one of: a client mortgage service identifier and corresponding client status indicator, a client closing service identifier and corresponding client status indicator, a client moving service identifier and corresponding client status indicator, a client insurance service identifier and corresponding client status indicator, or a client renovation service identifier and corresponding client status indicator.

In some embodiments of these methods, each of the corresponding client status indicators include one a client value or a non-client value.

In some embodiments of these methods, the current market rating value includes one of a seller strong rating value, a seller balanced rating value, a seller weak rating value, a trending seller rating value, a balanced rating value, a trending buyer rating value, a buyer weak rating value, a buyer balanced rating value and a buyer strong rating value.

In some embodiments of these methods, the current market trend value includes one of a seller's market value, a balanced market value and a buyer's market value.

In some embodiments of these methods, the client specialty value includes at least one of a veteran buyer value, a first-time buyer value, an investor buyer value, a vacation property buyer value, a retiree buyer value, a court ordered seller value, a trustee seller value, a short sale seller value, and an investor seller value.

Certain preferred embodiments of this invention provide other methods for creating, storing and retrieving a message record configured to be distributed to a client and an agent of the client over a course of a real estate transaction of the client. These other methods comprise at least some of the following, such as: (a) providing a system application server including a memory for storing processor instructions and a processor for executing the processor instructions; (b) providing a system session server, in communication with the system application server, the system session server configured to establish and maintain a system session with and generate a message creation interface accessible by a message creator; (c) providing a user profile database, in communication with the system application server, the user profile database including a client profile record of the client (e.g., contact information and/or open-access engagement tools (e.g., user input preferences, such as budget, location, property type, etc., instead of contact information; an anonymized data tracking code)); and (d) providing a message database in communication with the system application server, the message database configured to store and retrieve a plurality of stored message records.

These other methods also comprise at least some of the following, such as: (e) receiving message creator input via the message creation interface, the message creator input including: at least one step of a plurality of progressive steps in a real estate transaction of the client, a target message destination section configured to be displayed on at least one user interface having a plurality of message destination sections, a client agent specific message configured to be displayed on a client agent user interface in a client agent specific message section, and a message record update date and timestamp value; (f) storing the message creator input in a message record within the message database; and (g) retrieving the message record from the message database based on a user profile record update in response to a change in a step value of the plurality of progressive steps in the real estate transaction of the client in the client profile record and matching at least one message creator input value to at least one data field in the client profile record.

Certain preferred embodiments of this invention provide still other methods for creating and storing a message record configured to be distributed to a client and an agent of the client over a course of a real estate transaction of the client. These other methods comprise at least some of the following, such as: (a) providing a system application server including a memory for storing processor instructions and a processor for executing the processor instructions; (b) providing a system session server, in communication with the system application server, the system session server configured to establish and maintain a system session with and generate a message creation interface accessible by a message creator; (c) providing a user profile database, in communication with the system application server, the user profile database including a client profile record of the client (e.g., contact information and/or open-access engagement tools (e.g., user input preferences, such as budget, location, property type, etc., instead of contact information; an anonymized data tracking code)); and (d) providing a message database in communication with the system application server, the message database configured to store and retrieve a plurality of stored message records.

These other methods also comprise at least some of the following, such as: (e) receiving message creator input via the message creation interface, the message creator input including at least one step of a plurality of progressive steps in a real estate transaction of the client; (f) storing the message creator input in a message record within the message database; and (g) retrieving the message record from the message database based on a user profile record update in response to a change in a step value of the plurality of progressive steps in the real estate transaction of the client in the client profile record and matching at least one message creator input value to at least one data field in the client profile record.

In certain of the most preferred embodiments of this invention, the platforms, systems and methods are flexible enough to accommodate implementations where users cannot select or reject particular agents.

These platforms, systems and methods may be provided on a computer-readable storage medium storing instructions that when executed by a computer cause the computer to perform a method for using a computer system to build a message record and managing communications relating to real estate transactions comprising the steps set forth above.

These platforms, systems and methods may also be provided on a memory for storing data for access by an application program being executed on a data processing system. This may comprise a data structure stored in the memory, the data structure including information resident in a database used by the application program and including a plurality of data objects configured to contain the information comprising that set forth above.

Advantages of the embodiments of this invention are described and apparent throughout this specification. Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description, figures, and appended claims.

### BRIEF DESCRIPTION OF THE DRAWINGS

FIG. 1 illustrates a schematic diagram of a preferred embodiment of a system disclosed herein.

FIG. 2 illustrates a schematic diagram of a time-based method of user interactions on multiple system user interfaces within the system and their interaction with a message database and a profile database.

FIG. 3 illustrates a schematic logical diagram of a method of creating an agent profile that will be stored in a profile database.

FIG. 4 illustrates an example of an agent profile that will be stored in a profile database.

FIG. 5 illustrates a schematic logical diagram of an embodiment of a method of creating both a buyer client profile record and a seller client profile record that will be stored in a profile database.

FIG. 6 illustrates a schematic logical diagram of a method of determining and assigning a current market rating value for a buyer client within the schematic logical diagram of the method of creating the buyer client profile record of FIG. 5.

FIG. 7 illustrates a schematic logical diagram of a method of determining and assigning a current market trend value for either a buyer client or a seller client within the schematic logical diagram of the method of creating both the buyer profile record and the seller profile record of FIG. 5.

FIG. 8 illustrates a schematic logical diagram of a method of determining and assigning a current market rating value for a seller client within the schematic logical diagram of the method of creating the seller client profile of FIG. 5.

FIG. 9 illustrates an embodiment of a continuation of the schematic logical diagram of the method of creating both the buyer profile record and the seller profile record that will be stored in the profile database of FIG. 5. In open-access engagement tools of certain embodiments of this invention, such personal information is not collected at initial stages, taking a more privacy-centric approach than that shown in FIG. 9.

FIG. 10 illustrates an exemplary buyer client profile record created by the method of FIGS. 5-7 and 9.

FIG. 11 illustrates an exemplary seller client profile record created by the method of FIGS. 5 and 7-9.

FIG. 12 illustrates a buyer agent user interface.

FIG. 13 illustrates a seller agent user interface.

FIG. 14 illustrates a buyer client user interface.

FIG. 15 illustrates a seller client user interface.

FIG. 16 illustrates an agent rating and performance metrics user interface.

FIG. 17 illustrates an additional client services provider user interface.

FIG. 18 illustrates an additional client services provider cumulative ratings user interface.

FIG. 19 illustrates a schematic logical diagram of first embodiment of a method of building a message record that is stored in a message database.

FIG. 20 illustrates a continuation of the schematic logical diagram of the first embodiment of the method of building the message record of FIG. 19.

FIG. 21 illustrates a further continuation of the schematic logical diagram of the first embodiment of the method of building the message record of FIGS. 19-20.

FIG. 22 illustrates a further continuation of the schematic logical diagram of the first embodiment of the method of building the message record of FIGS. 19-21.

FIG. 23 illustrates an exemplary message record created by the method of FIGS. 19-22.

FIG. 24 illustrates a schematic logical diagram of a method of distributing a stored message record from the message database to one of the three display output a reason the buyer and seller agent user interfaces and buyer client and seller user interfaces.

FIG. 25 illustrates a schematic workflow diagram of a method of client interaction with the system server via the buyer client user interface (of FIG. 14) or the seller client user interface (of FIG. 15).

FIG. 26 illustrates an exemplary buyer client user interface at a first step of the client real estate transactions maintained by the system corresponding to the first step of the user interface in FIG. 25.

FIG. 27 illustrates an exemplary buyer client user interface at a second step of the client transactions maintained by the system corresponding to the second step of the user interface in FIG. 25.

FIG. 28 illustrates an exemplary buyer client user interface at a third step of the client transactions maintained by the system corresponding to the third step of the user interface in FIG. 25.

FIG. 29 illustrates an exemplary buyer agent user interface at a fourth step of the client transactions maintained by the system corresponding to the fourth step of the user interface in FIG. 25.

FIG. 30 illustrates a schematic workflow diagram of the method of client interaction at the fourth step with three stages with the system server via the client user interface.

FIG. 31 illustrates an exemplary buyer client at a third stage of the fourth step of the client transactions maintained by the system corresponding to the fourth step of the user interface in FIG. 29.

FIG. 32 illustrates a schematic workflow diagram of the method of agent interaction at the fifth step with the system server via the agent user interface and the client user interface.

FIG. 33 illustrates an exemplary agent user interface of a method of a buyer agent updating a mortgage status of the buyer client according to FIG. 32.

FIG. 34 illustrates an exemplary buyer client user interface updated in accordance with the action of the buyer agent updating the mortgage status of the buyer client according to FIG. 32.

FIG. 35 illustrates a schematic workflow diagram of a method of client and agent interaction at the fifth step including eight stages and a client status stage with the system server via the buyer client or seller client user interface.

FIG. 36 illustrates continuation of the schematic workflow diagram of FIG. 35 of the method of client and agent interaction at the fifth step including eight stages and a client status stage with the system server via the buyer client or seller client user interface.

FIG. 37 illustrates an exemplary buyer agent user interface of a method of the buyer agent selecting a buyer client stage.

FIG. 38 illustrates an exemplary buyer client user interface of the method of FIG. 37 indicating the selection of the buyer agent on the buyer agent user interface.

FIG. 39 illustrates an exemplary seller agent user interface of a method of the seller agent selecting a seller client stage.

FIG. 40 illustrates an exemplary seller client user interface of the method of FIG. 39 indicating the selection of the seller agent on the seller agent user interface.

FIG. 41 illustrates continuation of the schematic workflow diagram of FIGS. 34-35 of the method of client and agent interaction at the fifth step including a client status indicator with the system server via the buyer client or seller client user interface.

FIG. 42 illustrates an exemplary buyer agent user interface of a method of the buyer agent selecting a buyer client status.

FIG. 43 illustrates an exemplary buyer client user interface of the method of FIG. 41 indicating the selection of the buyer agent of the buyer client status on the buyer agent user interface.

FIG. 44 illustrates an exemplary client report.

FIG. 45 illustrates an exemplary agent user interface where the agent has selected a system feedback interface element to report an issue to the system administrator.

FIG. 46 illustrates an agent reporting user interface that is presented to an agent who selects the system feedback interface element of FIG. 45.

FIG. 47 illustrates the agent reporting user interface of FIG. 46 wherein the agent user has selected an ID issue corresponding to a data field and value they would like to report.

FIG. 48 illustrates the agent reporting user interface of FIGS. 46-47 wherein the agent user has selected severity value corresponding to a data field and value they would like to report.

FIG. 49 illustrates the agent reporting user interface of FIGS. 46-48 wherein the agent user has input freeform details corresponding to a data field and value they would like to report and subsequently selects a submission interface element to submit the report information to the system administrator.

FIG. 50 illustrates a system administrator report user interface that presents an accumulation of agent feedback for all data fields in the agent and corresponding buyer client and seller user interfaces.

FIG. 51 illustrates an exemplary computer system configured to support any of the system computational servers of FIG. 1 to enable the methods of the embodiments disclosed herein.

### DETAILED DESCRIPTION OF THE INVENTION

Reference throughout this specification to “one embodiment,” “an embodiment, or similar language means that a particular feature, structure, or characteristic described in connection with the embodiment is included in at least one embodiment of the present invention. Appearances of the phrases “in one embodiment,” “in an embodiment and similar language throughout this specification may, but do not necessarily, all refer to the same embodiment.

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

### Key Technical Problems this Invention Addresses

The invention provides systems and methods for addressing key technical problems that plague the real estate sector with new and advantageous solutions. Certain of these technical problems and the solutions provided by this invention, some or all of which can be included in certain embodiments, include:

1. Information Overload: With the digital era's information explosion, clients (e.g., real estate buyers) find themselves drowning in a sea of data, leading to decision paralysis. Embodiments of this invention do not merely present information. They provide advanced filtering algorithms that curate content that aligns with a client's unique criteria, factoring in the current market condition—whether it's a buyer's, seller's, or balanced market, and also considering the market trend—be it trending towards buyers, sellers, or balanced. This is achieved through a deep-dive user profile assessment combined with real-time market analysis.

2. Lack of Personalization: Every client's journey is distinct, and generic, one-size-fits-all recommendations can significantly deter their progress. Embodiments of this invention provide an adaptive learning system that is not static. It evolves with the client, adapting to interactions, feedback, and changing preferences, ensuring property recommendations remain relevant.

3. Agent Alignment: With growing agent networks, maintaining a standardized service quality and adherence to company protocols becomes a herculean task. Embodiments of this invention provide integrated agent portals in that act as a real-time touchpoint. Beyond just updates, it's an interactive platform fostering agent growth, feedback, and alignment with the company vision.

4. Driving Agent Performance and Services Attachment: Traditional systems focus on after-the-fact performance reporting and, furthermore, clients aren't always aware of the full spectrum of available services. Embodiments of this invention provide a proactive system and methods that not only track but actively drive performance metrics. Its intuitive design ensures that clients are informed about a range of services like mortgages, legal aid, and others at the right moments.

5. Integration of Diverse Services: The fragmented nature of real estate services often compels clients to jump between platforms. Embodiments of this invention offer a comprehensive suite of integrated services, from property viewing to final transaction closure. Partnerships enable access to additional services like mortgages, legal aid, and moving assistance, ensuring a seamless transaction process.

6. Feedback Mechanisms: Delayed feedback collection can lead to outdated data. Embodiments of this invention provide real-time feedback tools that capture client experiences at pivotal points in their journey, allowing businesses to dynamically adjust their offerings for maximum client satisfaction.

7. Client Trust Issues: The shift towards digital platforms, while efficient, often distances clients due to a perceived lack of transparency and personal touch. Embodiments of this invention provide transparency features demystify the real estate transfer process, providing clients with a clear, step-by-step view of their real estate journey, fostering a sense of security and trust.

8. Data-Driven Decision Making: The sheer volume of collected data can be overwhelming, often leading to paralysis by analysis. Embodiments of this invention simplify complexity. Their analytics tools process this data, transforming it into digestible, actionable insights that businesses can leverage for strategic decisions.

9. Reliable Independent Source of Information: In an era of information skepticism, clients often seek a secondary, neutral source of advice. Embodiments of this invention fill this void, drawing from the collective wisdom of top-performing agents, and offering unbiased advice. This not only provides validation for clients but enriches their decision-making process.

10. Empowering Agents with Timely Information and Training: When new services or significant changes in real estate emerge that could impact a client's specific situation, both the client and the supporting agent need to be informed. Moreover, agents require more in-depth knowledge and training to advise clients effectively. Embodiments of this invention address the symbiotic relationship between clients and their supporting agents. When there is a new service or a notable change in the real estate landscape that affects a client, these embodiments ensure that both the client and their supporting agent are advised of it. While the client receives pertinent information to keep them updated, the agent gets both this information and additional training materials via their dashboard. This dual-channel approach guarantees that agents are not only informed but are also equipped with the tools and training they need to provide expert advice. The aim of these embodiments is to guarantee that agents possess both the knowledge and the know-how to offer clients exceptional service, maintaining trust and promoting effective communication.

While technology continues to revolutionize industries, the essence of real estate remains in human connection. Embodiments of this invention recognize and commit to this philosophy by providing meticulously designed tools that not only address the modern challenges of the real estate sector but also underscore the importance of informed and well-trained agents, working in tandem with their clients.

### Open Access Engagement Tools and Privacy Centric Embodiments

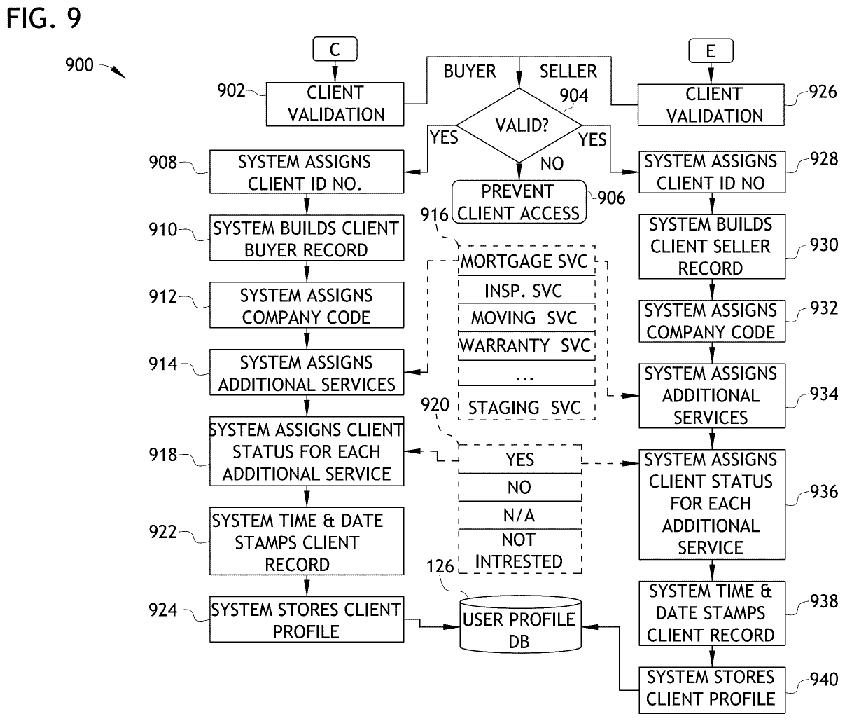

In certain of the most preferred embodiments of this invention, open-access engagement tools are used when capturing leads. In these embodiments, the previous uses of immediate contact data (e.g., some of which are described in alternative embodiments such as shown in part in FIG. 9) and/or behavioral tracking are either not performed, or they are used in conjunction with and/or subordinate to these open-access engagement tools.

These open-access engagement tools: (1) eliminate the need for upfront contact data, allowing personalized engagement without personal information; (2) gather user input preferences (e.g., budget, location, property type, etc.) and deliver personalized content based on this input rather than inferred data; (3) are rules-based and non-intrusive, maintaining user privacy while providing continuous personalized resources; and (4) expand visitor engagement, capturing early-stage and high visitors alike, providing a comprehensive engagement solution in the real estate technology market.

In conventional lead capture systems, user access to personalized resources and insights is typically gated behind contact data requests. Platforms like BoomTown, KVCORE, and Ylopo, for instance, capture leads by requiring personal information upfront or by using inferred behavioral analytics to determine user intent. Embodiments of this invention that use open-access engagement tools, however, flip this paradigm. By enabling users to explore personalized resources without the need to provide contact information, these embodiments open a unique gateway to visitor engagement.

This shift from gated to open-access engagement is a defining feature of these embodiments that presents an entirely new category of lead capture, which represents a significant departure from the conventional high-pressure data-collection systems used in previous real estate technology. This approach creates a user-friendly, non-intrusive experience, encouraging users to remain engaged without requiring immediate commitment.

The open-access engagement tools of this invention provide platforms, systems and methods that operate differently from the past in how they capture, retain, and nurture leads.

Traditional lead capture tools primarily focus on obtaining contact data quickly to enable follow-ups, whereas open-access engagement tools of this invention leverage user-stated preferences to deliver relevant content without requiring upfront personal data.

For example, in certain of these embodiments, important user (e.g., buyer) information (such as budget, location, and property preferences) is gathered directly from the user without requiring contact details. By not relying on behavior tracking or AI inference but rather on stated preferences, these embodiments are further differentiated from existing technologies. In certain of these embodiments of this invention, continuous access to personalized resources is provided, creating a customized, evolving experience within the agent's existing website.

Advantages of the embodiments using the open-access engagement tools of this invention will be readily apparent to a person of skill in the art. These embodiments are intentionally user-centric, providing an environment where visitors can engage freely without feeling pressured to share their information prematurely. A HubSpot study shows that 65% of users abandon websites when asked for personal data too early, underscoring how intrusive data requirements can deter engagement. By capturing this unique user-focused aspect of these embodiments, these embodiments not only offer a technical advancement but also improves use experience significantly over traditional systems. This non-intrusive, welcoming approach lowers barriers to engagement and fosters trust. This leads to higher visitor retention and extended engagement, making these embodiments using open-access engagement tools of this invention not only distinctive but also highly effective.

These open-access engagement tools allow these embodiments to capture and nurture a wider range of website visitors, from early-stage browsers to high-intent users, without requiring contact information. Traditional lead generation systems are confined to high-intent users who are willing to share their details immediately. These embodiments, on the other hand, broaden this scope, capturing early-stage leads that other systems might overlook. By offering access to personalized resources from the start, these embodiments can build meaningful relationships with these visitors over time, creating a pipeline of qualified prospects.

These embodiments are a market innovation, and, in particular, a shift from targeting immediate leads to building a comprehensive audience engagement strategy. The ability of these embodiments to engage users across the entire spectrum of the buying journey, ensuring long-term brand loyalty and engagement without invasive tactics. This distinction positions these embodiments as a market leader in inclusive lead capture.

Advantages of these open-access engagement tools include the following, as well as additional advantages that will be apparent to a person of skill in the art practicing these embodiments:

1. Privacy-Centric Approach: In an environment where data privacy is a major concern, certain embodiments of this invention provide personalized messages without requiring personal data, which is highly innovative and a break from the past. This directly addresses privacy concerns and regulatory requirements such as GDPR and CCPA in a novel manner.

2. Technical Challenge: Achieving personalization without relying on personal data is a complex technical challenge. Certain embodiments of this invention use proxy indicators, including company code, step, price tier, state, and client type, to infer relevance—allowing personalization while avoiding personal information collection. This approach is an effective workaround to a problem faced by most personalization technologies today.

3. Differentiation from Existing Systems: Most systems require personal data to function effectively. By successfully providing personalization without such data, the approach of certain embodiments of this invention sets them apart, making them a unique innovation in the field.

4. User Engagement and Conversion: Many users abandon real estate websites when asked to provide personal information during signup. By eliminating the need for personal data to access and interact with the system, certain embodiments of this invention encourage more users to engage, resulting in greater interaction and ultimately more clients for agents. Users only need to share their personal information once they decide to move forward with an agent, which significantly reduces friction early in the process.

5. Broad Applicability: While this invention is designed for real estate, this privacy-preserving personalization concept has broad applications across industries, which can demonstrate its wider utility.

6. Addressing a Market Need: There is growing demand for solutions that respect user privacy while delivering personalized experiences. Certain embodiments of this invention directly address this need, which adds value to the platforms, systems, and methods.

7. Overcoming Traditional Limitations: Typically, personalization quality is believed to be linked to the amount of personal data available. These open-access engagement tools challenge that assumption, opening up new opportunities in personalization technology.

8. Compliance and Ethics: By not requiring personal data, the open-access engagement tools of this invention inherently support compliance with data protection regulations and align with ethical data use practices, which is an increasingly important aspect of technology development.

These aspects collectively transform these embodiments from a conventional messaging system into an innovative solution that tackles both technological and societal challenges. The privacy-centric design, along with the complex rules-based distribution logic, supports the system's novelty and usefulness over previous systems.

### Anonymized Data Tracking Using a Code

This invention provides innovative tools designed to transform user interaction in the real estate industry by providing automated, personalized advice to potential homebuyers without direct agent involvement. One key feature of preferred embodiments is an anonymized data tracking system, which assigns each user a unique 12-digit code (other similar multi-digit or highly informational codes can also be used) to maintain privacy while enabling agents to monitor engagement and understand user behavior.

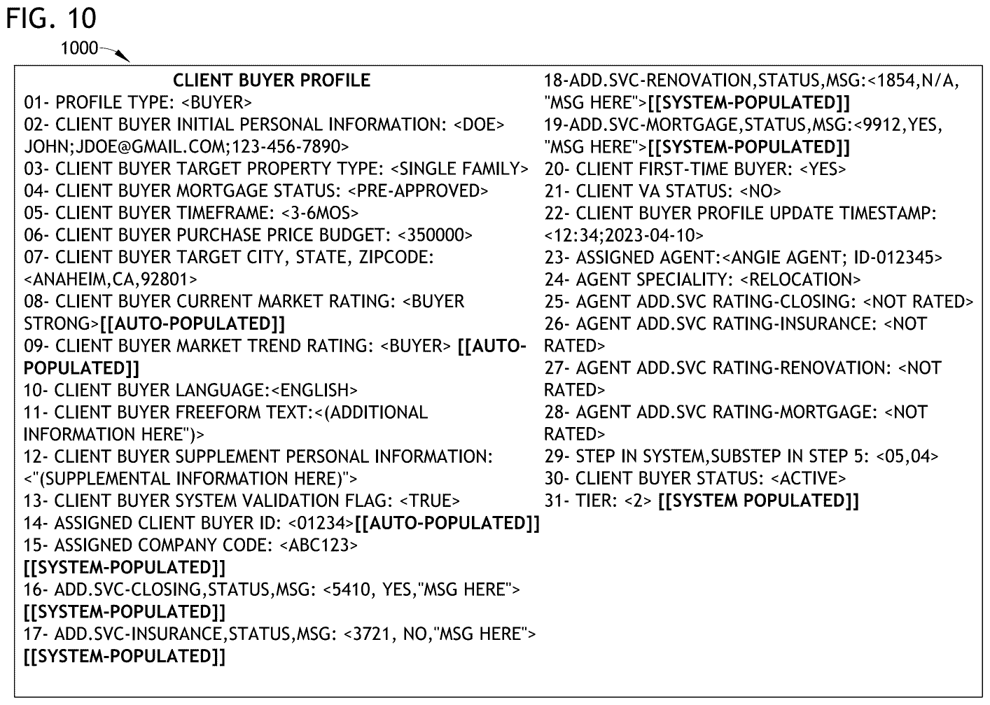

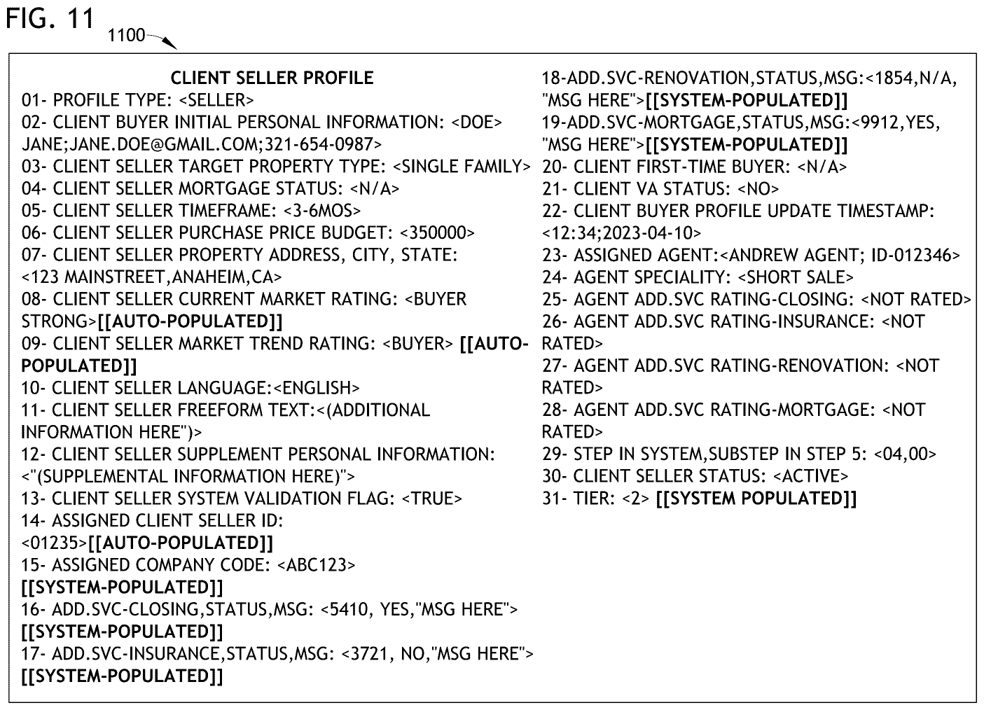

For example, an anonymized tracking system of preferred embodiments of this invention can use a unique 12-digit code assigned to each user who interacts with the platform. This assigned 12-digit code is referenced in FIGS. 10 and 11 as #14, the assigned buyer/seller ID. The first four characters of this code represent the month, day, and year of interaction. The first character is a letter indicating the month, starting with “A” for January, “B” for February, and so on. The next two characters are numeric, representing the day of the month (e.g., “01” for the 1st day). The fourth character is also a letter representing the year, starting with “A” for 2024, “B” for 2025, and so forth. For example, a code starting with “B08A” indicates that the user interaction took place on Feb. 8, 2024. The remaining eight characters are randomly assigned, ensuring that each code is unique for that day.

This system allows agents to see when users engaged with the platform while maintaining anonymity. Agents do not have access to personal information such as names or contact details but can still track interaction patterns, understand which content was accessed, and assess the system's effectiveness in guiding potential clients.

The embodiments of this invention that use an anonymized tracking system offer several benefits to real estate agents. First, it allows agents to gauge user engagement without requiring upfront identification. Agents can see how many users interacted with their website on any given day and which features of the website were most frequently accessed. This data helps agents refine their marketing efforts, improve automated services, and better understand what users are looking for at different stages of the home-buying process.

Additionally, the system provides agents with insights into user behavior over time. By understanding when users interact with the system and what information they seek, agents can determine which topics are of greatest interest. For example, if many users access information about mortgage options in June, agents could focus their marketing on financial assistance during that time. These insights help agents improve their business strategies without compromising user privacy.

The code (e.g., 12-digit code) system of these embodiments addresses concerns about data privacy and user consent. Unlike traditional customer relationship management (CRM) systems that require personal details, these embodiments enable users to engage anonymously, providing personalized advice without revealing their identity. This approach respects users' desire for privacy while still offering valuable insights to agents.

Tracking user interaction by date and behavior rather than personal information ensures that these embodiments comply with modern data privacy standards. By separating user data from personal identification, the system reduces the risks associated with data breaches or misuse. This feature aligns with broader trends in the technology industry, as companies shift toward privacy-centric models in response to regulations like the General Data Protection Regulation (GDPR).

This anonymized multi-digit (e.g., 12-digit) code system represents a significant advancement in user interaction tracking, offering agents valuable insights while ensuring user privacy. By assigning a unique code that incorporates the interaction date and anonymized data, these systems enable agents to monitor engagement, refine their strategies, and enhance the home-buying experience without compromising personal information. This privacy-focused approach is both innovative and crucial in an era where data protection and user consent are top priorities. Anonymized tracking offers a blueprint for future technologies seeking to balance personalization and privacy effectively.

### Overview of the Systems/Methods of this Invention

The systems and methods of this invention are designed to optimize real estate interactions. Certain embodiments use a set of core components (e.g., provided in segments and/or modules) that comprise:

1. User Database: The User Database stores user-specific information using Relational or NoSQL databases. It offers the benefit of having centralized user management improving data integrity and security.

2. Message Database: The Message Database contains messages that users send and receive using message queuing systems like RabbitMQ or Apache Kafka. It offers the benefit of providing efficient and timely message distribution, enhancing communication flow.

3. Client Profile Database: The Client Profile Database holds details about users' preferences and behaviors and adapts as clients progress through buying/selling stages. It offers the benefit of providing personalized, dynamic user interactions based on real-time data.

4. Client Report Database: The Client Report Database stores PDF files for full client record access. It offers the benefit of facilitating detailed reporting and data retention.

5. Application Server: The Application Server acts as the interface between all databases. It offers the benefit of streamlined request processing and real-time data retrieval for timely message dissemination.

6. API: API facilitates interaction with all databases. It offers the benefit of providing integration capabilities with other services and applications for enhanced functionalities.

7. Authentication & Authorization: Authentication & Authorization provides mechanisms using standards like OAuth2 or JWT. It offers the benefit of ensuring data security and user-specific access controls.

8. Scalability & Availability: Scalability & Availability provides deployment on cloud platforms. It offers the benefit of ensuring the systems' uninterrupted accessibility and adaptability to traffic surges.

8. Data Synchronization: Data Synchronization maintains consistency among all databases. It offers the benefit of accurate, up-to-date data across the system, enhancing reliability and performance.

In essence, the invention's modular design ensures efficient real estate interactions, capitalizing on real-time data to offer personalized, secure, and scalable solutions.

### Client Profile

In the present-day digital domain of real estate, the importance of delivering a custom-tailored experience to all clients—be they buyers or sellers—is important. Conventional systems often dispense broad, one-size-fits-all information that doesn't align with individualized needs or phases in the real estate process. The present need is for a system that is not static, but dynamically evolves with the client, disseminating precise, real-time data based on the client's specific stage and unique circumstances.

The Client Profile within this invention is devised with a state-of-the-art digital structure, aimed at adapting, recording, and responding to the diverse details and continuously changing phases of a client's real estate journey, whether they're looking to buy or sell. The capabilities of the Client Profile (e.g., provided in segments and/or modules) include the following:

Dynamic Nature: Diverging from traditional static frameworks, the Client Profile is defined by its fluid nature. As clients navigate through their journey—whether it's transitioning from property browsing to engaging with mortgage providers or preparing a property for listing—the profile acknowledges this progression in real-time.

Automated Messaging System: At the core of the Client Profile's potency is its innovative automated messaging mechanism. As the Client Profile undergoes changes, be it from milestones like aligning with a mortgage provider or deciding on a property listing price, the system springs into action, automatically generating messages perfectly aligned with the client's immediate needs and circumstances.

Benefits: The multiple benefits provided by the Client Profile aspects of this invention include the following;

1. Scalable Personalization: The concept of personalization in real estate, achieves groundbreaking scalability with the Client Profile. This ensures that each client's distinct journey, whether buying or selling, is acknowledged and addressed, leading to enhanced system efficiency.

2. Facilitating Prompt Decisions: Timely and accurate messages empower clients to make knowledgeable decisions promptly, removing the usual hurdles and indecisions of the property transaction journey.

3. Elevated Client Satisfaction: The custom experience made possible by the dynamic profile coupled with the intelligent messaging system heightens client trust, satisfaction, and dedication to the process.

4. Agent and Service Provider Efficiency: With the Client Profile rendering a comprehensive insight into the client's journey, agents and service providers can perfectly align their strategies with the system's advice and recommendations, ensuring the clients path is constantly optimized.

5. Uniqueness: The standout feature of the Client Profile is its unparalleled ability to meld real-time profile adaptation with a sophisticated messaging system. This invention cohesively integrates them, ensuring the client's journey, be it buying or selling, is always in alignment with real-time needs and changes.

The Client Profile within the systems and methods of this invention represents a significant advancement in real estate technology. It addresses the industry's pressing requirement for real-time personalization and contextually relevant messaging, optimizing the overall experience for both buyers and sellers. Through its dynamically adaptive nature and synchronized messaging capabilities, the system sets a new standard for digital client experiences in real estate.

### Buyer Agent User Interface (UI)

The Agent Dashboard is an important aspect of certain embodiments of the systems and methods of this invention, and marks a transformative shift in real estate interactions. Seamlessly integrating advanced technology with the nuanced dynamics of the agent-client relationship, this dashboard is not merely an adjunct tool but a holistic solution. Designed specifically to fortify the synergy between buyers and their agents, it emphasizes cohesiveness, transparency, and enhanced collaboration. The capabilities (e.g., provided in segments and/or modules) include the following:

Upon entry, agents encounter a dashboard, both sophisticated and user-centric. It unfolds into eight meticulously curated sections, each mirroring the multifaceted nature of real estate transactions and emphasizing cooperative buyer-agent engagements.

The ‘What Happens Next’ segment acts as a beacon, illuminating the property acquisition pathway for agents. It presents a transparent roadmap, providing agents with anticipatory insights about ensuing stages, positioning them to navigate buyers with informed clarity.

Within the ‘Recommendation’ module, agents find a dynamic reservoir of insights. It actively mirrors the guidance, tips, and recommendations that the system shares with the buyer via their dashboard. Far from being siloed suggestions, these are reflections of comprehensive market analysis, ensuring agents have a synchronized understanding, parallel to what the buyer perceives.

The ‘Reports’ section blossoms as a rich repository of actionable intelligence, encompassing ‘Expert Tips’, ‘Additional Services’, and ‘Insights’. These are tailored to match the buyer's journey, transforming agents into well-prepared consultants always on the same page as their clients.

The ‘Tell Us’ feature emphasizes the invention's commitment to continuous evolution. This real-time feedback channel, linking agents to system developers, is a testament to the platform's dedication to being shaped by its most vital users.

The transformative ‘Agent Message’ area provides agents with supplementary details that accompany the tips or recommendations shared with the buyer. This synchronization ensures agents are not only reactive but proactively equipped to address buyer queries or concerns, reinforcing their image as trusted and informed partners.

The ‘Buyer Property Data’ module combines buyer preferences with up-to-the-minute market insights. Such a fusion enables agents to make predictions, guide clients based on market trends, and stay attuned to buyers' evolving preferences.

With the ‘Buyer Contact’ segment, agents are afforded the luxury of streamlined communication. An intuitive switch mechanism facilitates swift access to buyer-specific communications, embodying both efficiency and timeliness.

The dashboard's hallmark is its adaptability. Recognizing the fluid nature of real estate interactions, it offers agents the facility to swiftly update buyer statuses, ensuring a real-time and harmonized flow of information.

The Agent Dashboard redefines the paradigm of real estate technology. By presenting agents with an aligned view of the information that the buyer receives, it facilitates a collaborative and harmonized working dynamic. This synchronized approach, blending the expertise of agents with cutting-edge technology, promotes a transparent, informed, and cohesive buying experience. Through this harmonization, the Agent Dashboard underscores a future where technology and human expertise work in unison, fostering a collaborative and efficient real estate ecosystem.

### Seller Agent User Interface (UI)

In the intricate tapestry of the real estate sector, the Seller Agent Dashboard emerges as a groundbreaking component of embodiments of the systems and methods of this invention. Seamlessly weaving advanced technology with the nuanced demands of the agent-seller partnership, this dashboard offers more than just support—it offers synergy. It's meticulously designed to augment the collaboration between sellers and their agents, ensuring fluidity, transparency, and an enriched selling experience. The capabilities (e.g., provided in segments and/or modules) include the following:

Upon accessing the dashboard, seller agents are greeted with an interface that is both sophisticated and seller-centric. Comprising eight distinct sections, each element is fine-tuned to mirror the complexities and requirements of the real estate selling process, ensuring a harmonized agent-seller interaction.

The ‘What Happens Next’ segment acts as a guiding light for agents, elucidating the path ahead in the property selling process. It offers a clear roadmap, arming agents with insights regarding the subsequent stages of a seller's journey, empowering them to guide sellers with informed clarity and foresight.

The ‘Recommendation’ module stands out as a pivotal ally for seller agents. It actively reflects the guidance, tips, and strategies that the system shares with the seller via their dashboard. These insights, a culmination of comprehensive market research and analysis, ensure that agents maintain a cohesive perspective in alignment with what the seller receives.

The ‘Reports’ arena unravels as a treasure trove of actionable insights, including ‘Expert Tips’, ‘Additional Services’, and ‘Insights’. Aligned with the seller's journey, these facets ensure that agents can anticipate and respond to seller queries or concerns, bolstering their role as trusted advisors.

The ‘Tell Us’ feature underscores the invention's dedication to evolution. This real-time feedback mechanism, bridging agents and system developers, encapsulates the platform's commitment to evolving based on ground-level insights and feedback.

The ‘Seller Message’ section is especially transformative. Here, agents receive comprehensive information accompanying the tips or strategies presented to the seller. This congruence guarantees that agents are proactively primed to address any seller queries, enhancing their role as informed and synchronized partners.

The ‘Seller Property Data’ segment fuses seller preferences with real-time market data. This blend grants agents the foresight to guide sellers based on prevailing market dynamics, ensuring that pricing and listing strategies are optimized.

Navigating the ‘Seller Contact’ module, agents benefit from streamlined communication. An intuitive interface ensures quick access to seller-specific interactions, epitomizing both responsiveness and precision.

One of the crowning features of this dashboard is its adaptability. In a sector as fluid as real estate, it allows agents to swiftly modify seller statuses, guaranteeing a real-time and synchronized information flow.

The Seller Agent Dashboard is poised to redefine the technological landscape of real estate for sellers. By offering agents a parallel view of the insights and information presented to the seller, it establishes a foundation for cohesive, informed, and efficient seller-agent collaboration. Through this synchronized approach, the Seller Agent Dashboard paves the way for a future where technology and human expertise merge seamlessly, enhancing the overall selling experience and sculpting a new era for the real estate industry.

### Buyer Client User Interface (UI)

In the ever-evolving landscape of real estate, navigating the intricate steps of buying a property can often be a daunting endeavor. Recognizing this challenge, embodiments of the systems and methods of this invention introduces an innovative solution—the Buyer Dashboard. This interface is tailor-made for prospective property buyers, ensuring they have a guided, informed, and streamlined property acquisition journey. The capabilities (e.g., provided in segments and/or modules) include the following:

‘What Happens Next’: Specifically oriented towards buyers, this interactive roadmap adjusts based on the buyer's progression, elucidating the subsequent steps of their purchasing journey. It's more than just a checklist—it provides insights and expectations for the next stages, ensuring buyers remain proactive and confident.

‘Recommendation’: Leveraging advanced algorithms, this section deduces the buyer's position in the acquisition cycle, offering precise suggestions to guide them seamlessly through every decision point.

‘Reports’: This segment provides buyer-centric analytics. The ‘Expert Tips’ feature provides insights from seasoned professionals, tailored to the buyer's unique circumstances and market position, facilitating informed decisions.

‘Additional Services’: Catering to buyers' needs, this section introduces relevant services, such as mortgage consultants, legal aids, or property valuation experts, integrating them at the right moment to ensure every buyer's requirement is addressed.

‘Insights’: Acting as a continuous knowledge stream, it offers articles and updates that are pertinent to buyers, helping them understand market dynamics, pricing strategies, and other relevant facets.

‘Home Search & Recommendations’: This tool, leveraging AI capabilities, refines property suggestions to align with the buyer's preferences and budget, making the search process more intuitive and productive.

‘Buyer Data & Market Analysis’: Tailored for buyers, this section fuses overarching market trends with buyer-specific data, offering insights on pricing, locality advantages, and more, all personalized to the buyer's perspective.

Progress Visualization Segment: A unique feature of embodiments of the systems and methods of this invention include this section, which provides real-time visualization of a buyer's journey. Agents have the capability to manually update specific progress markers, ensuring both the buyer and agent stay aligned. This shared view fosters collaborative decision-making.

Given the dynamic nature of property buying, financial aspects play a pivotal role. Depending on the buyer's mortgage status and financial position, the dashboard offers actionable advice and recommendations. By continuously updating its contents in real-time as the buyer advances, it ensures that both the buyer and the agent have synchronized access to the same insights, fostering harmonious collaboration.

In summation, the Buyer Dashboard of these embodiments is a game-changer in the real estate tech domain. Tailored specifically for buyers, it amalgamates technological prowess, expert insights, and a user-centric design to revolutionize the property-buying experience. By offering real-time updates, personalized recommendations, and collaborative features, it empowers buyers and their agents to work in tandem, ensuring informed decisions throughout the property acquisition journey.

### Seller Client User Interface (UI)

In the intricate realm of real estate, selling a property introduces its own unique set of challenges and complexities. Responding to the pressing needs of property sellers, embodiments of the systems and methods of this invention provide a Seller Dashboard. This innovative interface is meticulously crafted for individuals and entities looking to sell properties, ensuring they are equipped, informed, and poised for a successful transaction. The capabilities (e.g., provided in segments and/or modules) include the following:

‘What Happens Next’: Designed with sellers in mind, this dynamic roadmap evolves based on the seller's journey. It doesn't just list tasks but offers clarity on upcoming milestones in the property selling process. This proactive approach helps sellers understand and anticipate the subsequent phases, giving them control and confidence in their decisions.

‘Recommendation’: Through sophisticated algorithms, this section interprets the seller's progression in the real estate cycle, dispensing precise advice tailored to guide them through each pivotal moment of their transaction.

‘Reports’: Here, sellers access crucial analytics geared towards their needs. The ‘Expert Tips’ feature imparts wisdom from real estate veterans, customized to the seller's specific circumstances, empowering them to make strategic decisions rooted in experience and data.

‘Additional Services’: Recognizing the integral role of closing services in a successful transaction, this segment timely introduces sellers to essential services such as closing agents, property appraisers, and legal consultants. By integrating these services at crucial junctures, the Seller Dashboard ensures the sale's legal and financial integrity.

‘Insights’: This continuously updated reservoir equips sellers with articles, market analyses, and selling strategies. From staging tips to understanding buyer psychographics, it provides sellers with a competitive edge in a demanding market.

‘Property Showcase & Recommendations’: This tool optimizes the presentation of the seller's property and recommends marketing strategies, ensuring the property resonates with the right audience and fetches optimum value.

‘Seller Data & Market Analysis’: Tailored for the seller's lens, this section juxtaposes macro market trends with property-specific data, offering insights on competitive pricing, neighborhood comparisons, and potential buyer demographics, all contextualized for the seller.

Progress Visualization Segment: This distinctive feature of embodiments of this invention provides real-time visualization of a seller's journey. Real estate agents can manually update specific progress indicators, creating a transparent, shared perspective between the seller and agent, promoting aligned decision-making.

Acknowledging the intricacies of property selling, the dashboard's focus on Seller Closing services is pivotal. Depending on the seller's position in the sales cycle, the dashboard curates actionable advice, ensuring that every legal, financial, and procedural aspect of the transaction is comprehensively addressed. With its real-time updates, it cultivates a synchronized, transparent communication channel between the seller and their agent.

The Seller Dashboard of embodiments of this invention is a transformative leap in the realm of real estate technology. Specifically sculpted for sellers, it amalgamates state-of-the-art technology, seasoned expertise, and user-centric design to redefine the property-selling paradigm. By furnishing real-time data, tailor-made advice, and collaborative elements, it empowers sellers and their agents to seamlessly navigate the intricate tapestry of property sales, ensuring every decision is informed, strategic, and aligned with the seller's objectives

### Agent Performance Metric Report Embodiments

Overview and Purpose: In the modern real estate landscape, a consistent challenge persists—i.e., equipping agents with real-time, comprehensive insights that optimize client interactions and elevate service utilization. Addressing this challenge, embodiments of this invention developed and use the Agent Performance Metrics Report. Unique in its approach, this report offers a real-time snapshot of an agent's interactions with clients and how well they are leveraging the additional services offered by the referral company. The capabilities (e.g., provided in segments and/or modules) include the following operational mechanisms and uniqueness:

Agent Details and Date Range: At the outset, the report captures fundamental data—the agent's unique ID and the date range for transactions. This forms the base layer, ensuring all subsequent analyses are contextually anchored.

Client Information: This section offers critical client-centric data, from client assignment date to their current status. It distinguishes clients based on their profile—buyer or seller. Additionally, the built-in pull-down menu enables agents to toggle between different clients, ensuring the flexibility of insight retrieval.

Additional Services and Ratings: Beyond transactional details, the report delves into the realm of service engagement. It not only captures the current level of client engagement with the offered services but also collects the agent's qualitative feedback. The feedback, categorized into Price, Quality, Service, and other discernible metrics, is designed to be intuitive and insightful. The ‘Current Client’ field's real-time update feature ensures fidelity in tracking service engagements, while the collected feedback aids ongoing service refinement.

Data Visualization: The data harvested isn't merely stored but is transformed into comprehensive graphic representations. Though not visible to agents, these visual outputs empower the referral company with an immediate understanding of service reception and areas of potential improvement. This visual data is malleable, with the capability to be viewed from multiple perspectives—by agent, geographical location, broker, and more. The transformative nature of this feature lies in its ability to convert raw data into actionable insights.

Agent Notes: This section allows agents to document qualitative observations, challenges, and more. These notes enhance intra-company communication, aiding problem resolution and ensuring that all stakeholders have a holistic understanding of the client's journey. An integrated ‘Update’ feature ensures data integrity and continuity.

Client Status by Category: Offering an expansive viewpoint, this section categorizes each client's transactional status. Agents gain a clear perspective of where each client resides in their real estate journey, enabling proactive strategizing and more successful future transactions.

Attachment Rate for Services: This final section elucidates the agent's efficiency in promoting additional services. By juxtaposing potential versus actual service utilization, an attachment rate is generated. This metric, presented in real-time, offers agents a mirror to their service promotion efficacy, ensuring alignment with broader company objectives.

The Agent Performance Metrics Report, developed for embodiments of this invention, is a pioneering solution in the real estate technological sphere. By amalgamating transactional data, service utilization, qualitative feedback, and visual insights, it ensures agents and referral companies remain in lockstep, promoting informed decision-making and continuous performance enhancement. The report embodies a transformative bridge between the agent's ground-level interactions and the referral company's strategic imperatives, sculpting a future where data-driven insights drive excellence in real estate.

### Internal Support Dashboard

The Internal Support Dashboard is a sophisticated tool integrated within embodiments of this invention. This dashboard is meticulously designed to assist internal support teams in promptly identifying clients, understanding their journey, and efficiently offering support for a myriad of additional services offered by referral companies. By streamlining tasks and presenting real-time insights, the dashboard not only optimizes the support process but also elevates the overall client experience. The capabilities (e.g., provided in segments and/or modules) include the following:

Dashboard Design And Layout: Upon accessing the embodiment of this invention, support staff are greeted by the Internal Support Dashboard, organized into seven clearly delineated sections. Each section is explicitly crafted to cater to specific facets of client interaction, ensuring that support teams have a panoramic view of the client's journey.

Client Data Section: At the dashboard's outset, support staff are provided with the foundational data, including the client's contact details, type (buyer/seller), current status in their real estate journey, and their associated agent's contact information.

Property Data Segment: This section delves into the nuances of a client's property interests, whether as a buyer or a seller. By offering specifics such as property type, location, and financial metrics, it enables the support team to tailor their assistance precisely.

Additional Services Interaction: More than just a tracking tool, this section offers real-time insights into a client's engagements with various additional services from the referral company. A drop-down menu lets support staff document the client's level of involvement, ensuring up-to-the-minute accuracy.

Automated Communications And Client's Journey: Recognizing that every client's journey may necessitate numerous system communications, a ‘System Communication Log’ is incorporated. This section meticulously logs every automated message dispatched, timestamped, and marked with the client's progress stage. Notably, support staff can view the entire content of messages, ensuring they're apprised of prior communications.

Collaborative Note-taking Features: The dashboard promotes seamless interdepartmental collaboration through two note-taking sections—‘Active Department Notes’ for real-time inputs and ‘Other Department Notes’ for visibility into insights from other teams. This feature ensures that all departments are continually updated, fostering a unified, consistent approach to client support.

Update Button: Central to data integrity, the dashboard includes an ‘Update’ button, locking in all session changes, ensuring that all modifications are appropriately captured.

Unique Selling Propositions (USPs): The Internal Support Dashboard distinguishes itself in several key ways:

1. Personalized Client View: The dashboard, by offering a detailed client view based on the logged-in support staff, ensures that each team member has a tailored experience, presenting only the most relevant information.

2. Collaborative Ecosystem: The dashboard fosters a synergistic approach to client support. With note-sharing features, departments can effortlessly communicate, ensuring a coherent and consistent client experience.

3. Real-time Service Engagement: The dashboard's dynamic design ensures that support teams can document and view real-time service engagement levels, offering a current snapshot of client interactions.

4. Centralized Communication History: By integrating a comprehensive log of system communications, the dashboard ensures that support teams are always informed of prior client messages, fostering continuity and consistency in client interactions.

The Internal Support Dashboard, within the embodiments of this invention, represents a novel approach to internal support in the realm of real estate referrals. It's not merely a tool but an ecosystem, driving efficiency, collaboration, and informed decision-making. By offering a real-time view into client interactions, promoting interdepartmental collaboration, and ensuring continuity in communications, it redefines the paradigm of client support, aligning with the ethos of delivering unparalleled client experiences.

### Additional Services & Ratings

In today's dynamic real estate landscape, understanding client engagements and optimizing service offerings is paramount. The ‘Additional Services & Ratings’ feature, embedded within the Agent Performance Metrics Report, stands as a testament to this modern imperative. The capabilities (e.g., provided in segments and/or modules) include the following:

Operational Depth and Breadth: At its core, this section acts as a rich repository, meticulously capturing a wide array of data points in real-time. As agents interface with various services, every interaction, every touchpoint, is documented. Whether a client shows interest in property valuation, legal consultations, or moving services, the system captures this engagement.

But beyond mere data logging, this section delves deeper. Agents, given their front-line interactions with clients, are in a unique position to provide qualitative feedback on these services. To harness this invaluable insight, the system offers agents the capability to rate the services on multiple criteria, from service efficiency, quality, and responsiveness to the overall client satisfaction. These ratings are not mere numbers; they encapsulate the very essence of client sentiment, translating abstract feelings into tangible metrics.

Feedback as a Dual-Edged Sword: While the immediate utility of this feedback mechanism is to offer agents and the referral company a snapshot of current client sentiments, its implications run much deeper. This feedback, in its aggregate form, provides the referral company with an eagle-eye view of how its services are received on the ground.

But more than just a passive reception mechanism, this feedback drives action. By highlighting areas of excellence and pinpointing potential pain points, it offers the referral company a roadmap for service refinement. If a particular service consistently receives lower ratings, it signals an area ripe for intervention, whether in the form of enhanced training, process refinement, or resource allocation.

Moreover, in an industry where client preferences and needs are ever-evolving, this continuous feedback loop ensures that the referral company remains agile. By aligning its service offerings with real-world client expectations, it ensures that its value proposition remains robust, relevant, and resonant.

Holistic Integration: The beauty of the ‘Additional Services & Ratings’ feature lies in its integration. It's not a standalone segment but is interwoven with other sections of the Agent Performance Metrics Report. For instance, agents' qualitative observations documented in the ‘Agent Notes’ section can offer context to the ratings, providing a more nuanced understanding.

The ‘Additional Services & Ratings’ section embodies the fusion of technologies precision with the invaluable human touch. By capturing real-time service engagements and marrying them with qualitative agent ratings, it provides a holistic picture of client interactions. More than just a data collection tool, it serves as a strategic asset, fostering informed decision-making, continuous service refinement, and ensuring that the referral company's offerings remain in perfect harmony with client expectations and needs.

### Message Building Systems and Methods

In the vast landscape of real estate technology, effective and personalized communication stands paramount. It's no longer sufficient to send generic messages; modern clients demand content tailored to their unique needs and preferences. With diverse client profiles and rapidly changing market dynamics, the challenge is to provide messages that are not only relevant but also timely, actionable, and engaging. The capabilities (e.g., provided in segments and/or modules) include the following:

An innovative Message Building System is provided in these embodiments that is meticulously designed to craft and distribute tailored messages for both clients and agents. This advanced system integrates a vast array of data points from user profiles, real-time activities, and market trends, curating personalized messages that resonate with the recipient's immediate context.

Benefits from these embodiments include:

1. Dynamic Personalization: The system automatically extracts pertinent data from user profiles and activities, ensuring that each message sent is tailored to the recipient's current needs, preferences, and status within the real estate journey.

2. Timely Communications: As users progress through the buying or selling process, the system responds in real-time, delivering messages aligned with their current phase. This ensures clients and agents always receive information relevant to their immediate context.

3. Efficiency and Reduced Redundancy: By curating messages based on user profiles and activities, the Message Building System avoids bombarding users with irrelevant or redundant information. This leads to increased engagement as recipients recognize the value in every communication received.

4. Enhanced Engagement: The system's ability to craft personalized messages ensures that clients and agents are more likely to engage with the content, leading to improved user satisfaction and better outcomes.

5. Data-Driven Insights: Beyond mere personalization, the system employs advanced analytics to optimize message content, timing, and delivery based on user engagement metrics.

This continuous learning approach refines the messaging strategy.

6. Seamless Integration with Other Systems: The Message Building System is designed to work in harmony with other components of embodiments of this invention, such as the real estate transition tracking, ensuring that messaging is always informed by the most up-to-date data.

7. Scalability: As the database of users grows and market dynamics evolve, the Message Building System is adept at scaling its operations, ensuring that the quality and relevance of messaging are consistently maintained.

8. Uniqueness: While many platforms might offer personalized messaging, the Message Building System of these embodiments stands distinct due to its deep integration with real-time user data, market insights, and dynamic adaptability. It is not a mere notification system but a comprehensive communication solution, meticulously crafted to understand, engage, and resonate with every individual user.

The Message Building System within these embodiments marks a pivotal advancement in the realm of real estate communication strategies. By championing dynamic personalization, real-time responsiveness, and data-driven optimization, it redefines the standards for user engagement and satisfaction. This system underscores the invention's commitment to placing the user at the heart of technological innovation, setting a new benchmark for tailored communication in the digital age.

### Message Distribution Systems and Methods

In the contemporary realm of real estate technology, ensuring effective communication is of paramount importance. Traditional communication methods, typified by mass-sent messages and generic notifications, often fall short in providing the precision and immediacy crucial for ideal client-agent interactions. The optimal solution should adjust its communication based on the dynamic profiles and evolving requirements of each client, fostering synchronization between clients, agents, and the referral companies throughout the entirety of their real estate journey. The capabilities (e.g., provided in segments and/or modules) include the following:

The Message Distribution System embodiments comprise an avant-garde communication structure tailored to streamline and individualize messages among the platform, agents, clients, and the referring company. This system, using a vast reservoir of data points, which includes dynamic client profiles and instantaneous updates, ensures communications remain contextually pertinent, timely, and actionable.

Benefits from these embodiments include:

1. Referral Company Engagement: Traditionally, once a client referral is made, the referring company often loses touch with the client. With embodiments of this invention, the referring company remains integrally involved, guiding the client through their real estate journey and ensuring the agent provides exemplary service. The system, thereby, bridges any engagement gap that might exist between the client and the referral company post the initial referral.

2. Proactive Support: Embodiments of this invention enable internal support teams to access real-time client data. This proactive approach ensures that any emerging issues are rapidly identified and addressed, enhancing the service quality experienced by clients. Moreover, when necessary, these embodiments promote engagement by the internal support team, further buttressing the quality of service clients receive.

3. Contextual Relevance: The Message Distribution System, unlike generic notifications, crafts every communication to mirror the client's current position, activities, and necessities. This specificity guarantees clients garner insights and recommendations germane to their current stage in the real estate progression.

4. Real-time Engagement: As clients transition through phases, such as aligning with a mortgage provider, the system acknowledges these shifts instantaneously. This reactive nature ensures the communication mirrors the client's most recent status and needs.

5. Enhanced Client-Agent Synchronization: The system keeps agents apprised of the messages dispatched to their clients, ensuring they remain informed and can align their strategies effectively with the platform's communications.

6. Efficiency and Reduced Redundancy: The system eschews sending unnecessary or repetitive messages, sparing clients from information deluge. This efficiency boosts client engagement rates, with clients appreciating the consistent relevance and value of the communications they receive.

7. Dynamic Adaptability: The system's innate ability to adapt means that as real estate market dynamics shift or new services emerge, the Message Distribution System can smoothly assimilate these modifications.

8. Improved Client Satisfaction: The punctual and tailored messaging approach augments the likelihood of clients feeling valued and comprehended, amplifying their trust in the platform, agents, and referring company.

9. Uniqueness: Numerous platforms employ messaging systems, but embodiments of the Message Distribution System distinguish themselves with their adaptability and pledge to relay contextually apposite communications. This system extends beyond rudimentary notifications, utilizing a profound grasp of each client's dynamic profile and their real-time actions, a hallmark unique to this invention.

The embodiments of the Message Distribution System herald a transformative advancement in real estate technological communication approaches. By ensuring perennial congruence among messages, client requirements, agent actions, and the referring company's objectives, the system confers unparalleled advantages, including client satisfaction and synergy among all stakeholders. Its ground-breaking approach to dynamic and context-sensitive communication should set the industry's gold standard, spotlighting the system's potential to revolutionize real estate engagements in this digital epoch.

### Varied Report Types

In the realm of real estate, effective communication goes beyond mere transmission of information. It's about presenting data in a manner that resonates, educates, and engages clients and agents. Traditional systems have relied heavily on singular modes of data representation, often failing to account for diverse user preferences and learning modalities. The demand is for a versatile platform that employs a variety of report types tailored to the unique needs and preferences of its users. The capabilities (e.g., provided in segments and/or modules) include the following:

Embodiments of the Varied Report Types transcend conventional communication barriers by embracing a multifaceted approach to report generation and dissemination. Recognizing the varied informational needs and consumption habits of its user base, these embodiments seamlessly integrate both static (like PDFs) and dynamic (like videos) report formats, tailored for different contexts and audiences.

Benefits from these embodiments may include:

1. Adaptive Learning Modes: Understanding that users assimilate information differently, embodiments offer both visual (videos) and textual (PDFs) formats. This caters to diverse learning styles, ensuring broader comprehension and engagement.

2. Comprehensive Data Representation: While PDF files offer the advantage of structured, printable data ideal for detailed analysis, videos can present complex concepts in an easily digestible and engaging manner. Together, they provide a holistic view of the information.

3. Enhanced Engagement: Dynamic videos, with their interactive potential, can captivate users, ensuring key messages are conveyed effectively. This boosts engagement rates and ensures users are more likely to act on the insights provided.

4. Flexibility in Information Consumption: Users can choose their preferred mode based on their current needs. Whether they're in a rush and prefer a quick video summary or have time to delve into a detailed PDF report, these embodiments cater to their varied paces and preferences.

5. Efficient Resource Allocation: By analyzing user interaction with varied report types, these embodiments can refine its content strategy, ensuring resources are channeled into producing the most effective report formats for different scenarios.

6. Improved Decision-making: With richer insights and varied perspectives afforded by multiple report formats, clients and agents are better equipped to make informed decisions.

7. Accessibility and Portability: PDFs offer the benefit of easy sharing, printing, and offline access, ensuring users can reference the data even without an active internet connection. On the other hand, videos can be streamed across devices, ensuring accessibility on-the-go.

8. Uniqueness: While many platforms offer report generation capabilities, these embodiments stand out with its integrated approach to varied report types. Its recognition of the value of diverse content formats, tailored to individual user needs, is a distinguishing feature. The system's capability to adapt and present information in the most effective format for a given context is a testament to its innovative design.

The Varied Report types feature within embodiments of this invention exemplifies the next frontier in real estate communication strategies. By leveraging multiple formats to present, educate, and engage, these embodiments ensure a more holistic, adaptable, and user-centric approach to information dissemination. This innovative multi-format strategy underscores the invention's commitment to optimizing user experience, engagement, and decision-making in the real estate sector.

### The ‘Tell Us’ Embodiments

The real estate sector's digital evolution, while revolutionary, often risks distancing the core understanding derived from ground-level interactions and experiences. Recognizing the invaluable insights brought forth by agents, embodiments of this invention include the ‘Tell Us’ feature. Unlike the conventional reliance on Artificial Intelligence, this innovation emphasizes Community Intelligence, harnessing insights directly from an expansive community of agents. The principal aim is to align technological solutions more closely with the real-world nuances of the real estate industry. The capabilities (e.g., provided in segments and/or modules) include the following:

Bridge between Agents and Developers: ‘Tell Us’ serves as a unique communication portal, bridging the gap between agents, who are the front-line users, and system developers. This ensures that the underlying technology remains in sync with real estate's ever-evolving demands, ensuring its efficacy and relevance.

Accountability Framework: The feature introduces an enhanced accountability system. In instances where agents identify discrepancies or inaccuracies, ‘Tell Us’ offers a streamlined mechanism for them to highlight and rectify these issues, reaffirming the invention's commitment to clarity and accuracy.

User-Friendly Interface: Integrated directly into the agent's dashboard, feedback initiation is effortless. Upon selecting the ‘Tell Us’ option, the interface automatically populates client-specific data, such as name, ID number, and property details. This ensures that feedback is not only precise but is also contextual, linked directly to specific client profiles.

Structured Feedback System: To pinpoint concerns, agents can indicate the exact step and phase in question. A severity dropdown further categorizes the issue, ensuring that the feedback is both comprehensive and categorized.

Detailed Insights: Beyond structured feedback, a designated space allows agents to provide a narrative, detailing concerns, or suggesting potential improvements. This ensures that while technology underpins the feature, the human perspective remains paramount.

Prompt Integration: Once feedback is submitted, it's instantly integrated into a dedicated ‘Tell Us’ database, reinforcing the platform's commitment to responsiveness and continuous improvement.

Aggregated Analysis: The individual feedback pieces are aggregated to form the Health Report. This isn't just an overview but provides a granular understanding of potential issues, categorized by sectors and their severity. It functions as an instantaneous diagnostic tool, providing clarity on areas needing attention.

Customized Exploration: While the Health Report offers a macro perspective, developers have the flexibility to delve deeper, creating custom reports that explore specific feedback areas more intricately.

The ‘Tell Us’ feature, conceptualized and developed as part of this invention, represents a groundbreaking innovation in the real estate technological domain. By harmoniously blending precise technology with the experiential wisdom of agents, it ensures that the digital platform remains anchored to the realities of the real estate market. This alignment not only enhances the user experience but also ensures that the platform remains at the forefront of the industry's evolving demands, delivering an experience that's both state-of-the-art and deeply rooted in human insights.

### Examples

The subject matter of this disclosure is now described with reference to the following examples set forth in the figures. These examples are provided for the purpose of illustration only, and the subject matter is not limited to these examples, but rather encompasses all variations which are evident as a result of the teaching provided herein.

### System Diagram

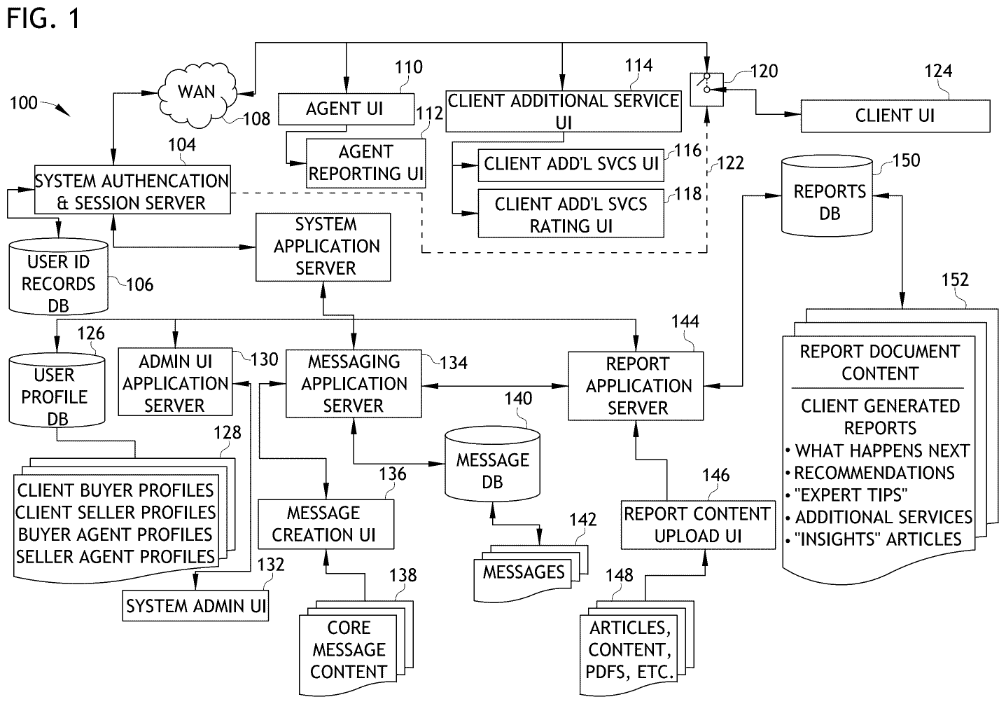

FIG. 1 illustrates a schematic diagram of a first embodiment of a system 100 disclosed herein. The system 100 has various connections, including to a Wide Area Network (WAN) 108, an Agent User Interface (UI) 110, Client Additional Services User Interface (UI) 114 and to a Client User Interface (UI) 124 controlled by a switch 120. A System Authentication & Session Server 104 is also connected to the WAN 108, the switch 120, a System Application Server 102 and User Identification (ID) and Record Database (DB) 106. Additional databases (126, 140, 150), servers (130, 134, 144), user interfaces (112, 116, 118, 132, 136, 146), interact to store and retrieve profiles 128, messages 138, articles and other content 148, and reports 152.

### System Method Diagram

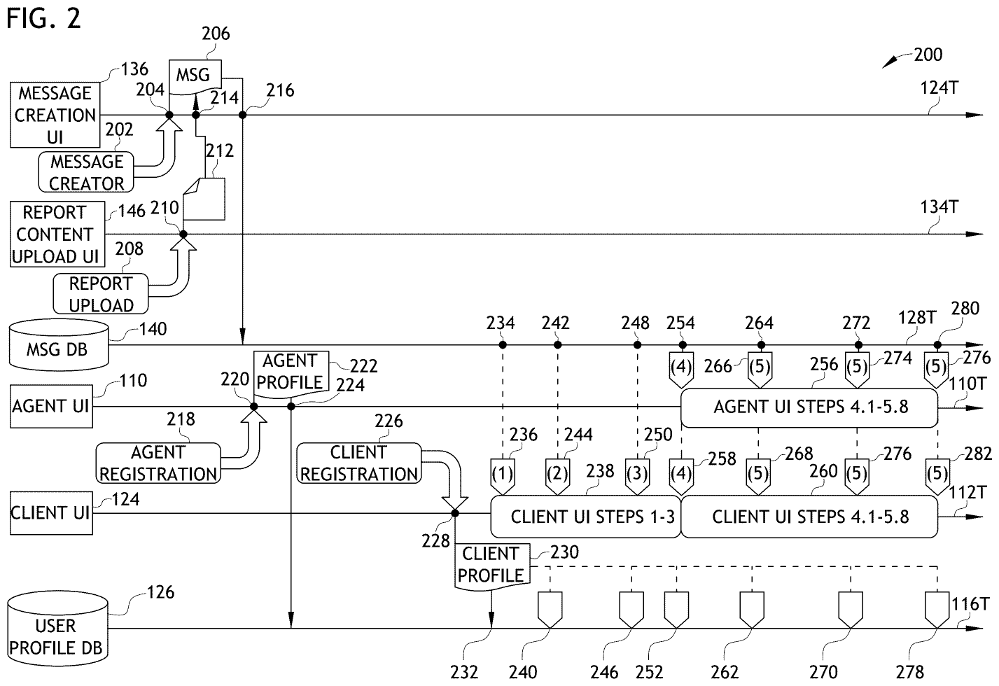

FIG. 2 illustrates a schematic diagram 200 of a time-based method of user interactions on multiple system user interfaces within the system and their interaction with a message database 140 and a profile database 125. User interfaces (UI) are identified (136, 146, 110, 124), that are used with message creation 202, report uploading 208, agent registration 218, and client registration 226 to create messages 206, upload reports 212, create agent profiles 222, and create client profiles 230.

### User Profiles: Agent User Profile Creation

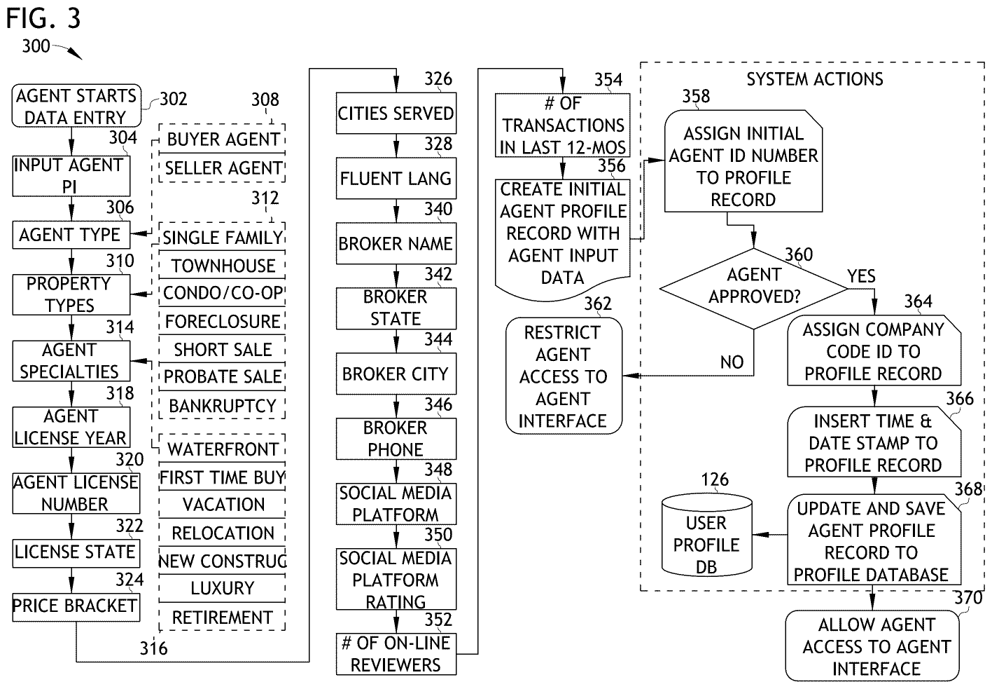

FIG. 3 illustrates a schematic logical diagram 300 of a method of creating an agent profile that will be stored in a profile database 126. Various data is input and collected (302 through 356), the agent is evaluated 360 and if approved allowed further access (364, 366, 368, 370). If not approved, the agent is restricted from access 362.

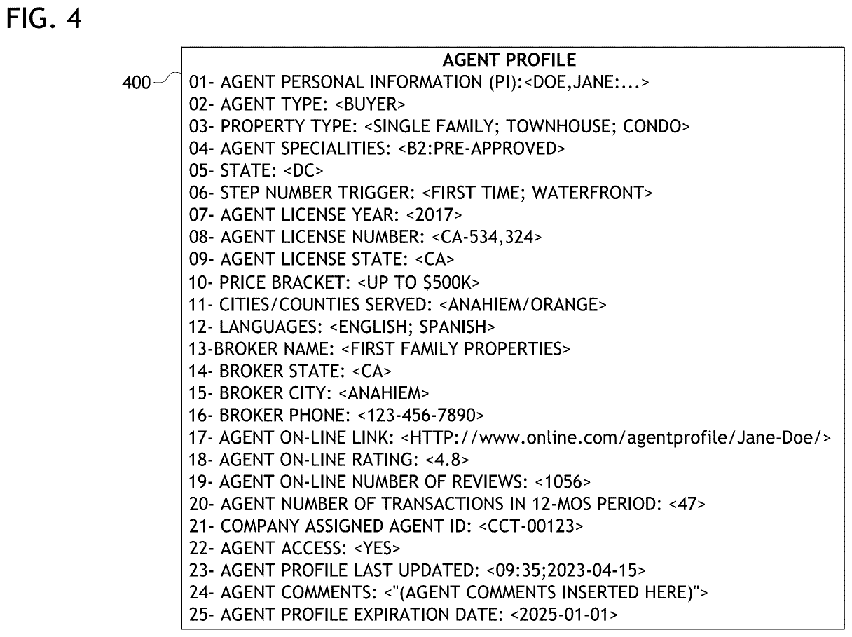

FIG. 4 illustrates a Agent User Profile 400 example, with types of information that may be input and collected (01 through 25).

### User Profiles: Client User Profile Creation

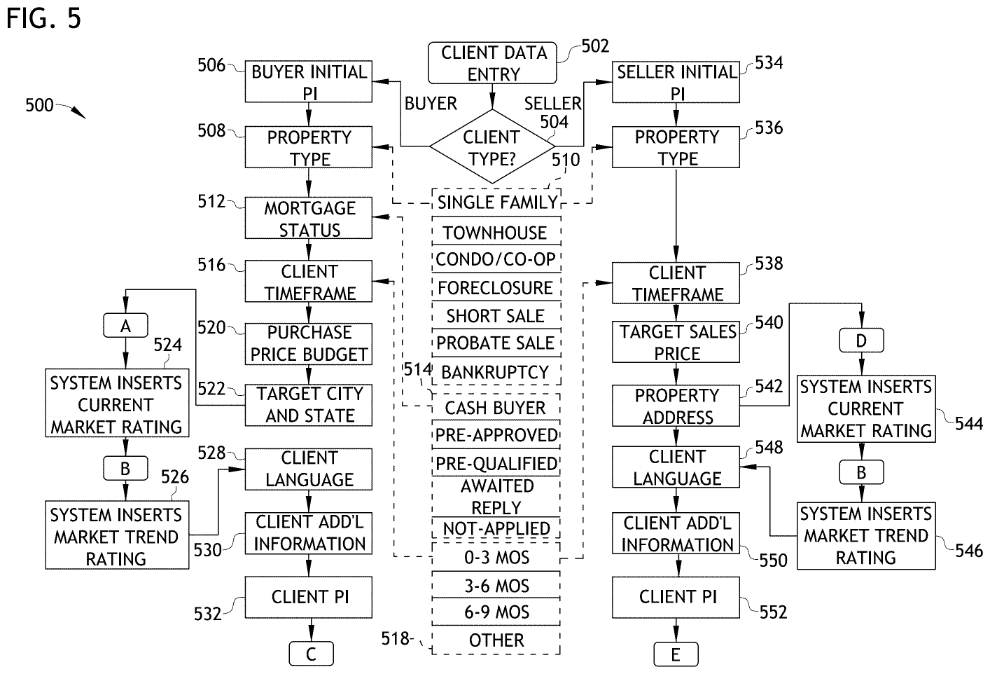

FIG. 5 illustrates a schematic logical diagram 500 of a method of creating both a buyer client profile record 532 and a seller client profile record 552 that will be stored in a profile database. The client data entry 502 begins with determining whether a client is a buyer or a seller 504. If a buyer, information is collected and input (506 through 532). If a seller, information is also collected and input (534 through 552).

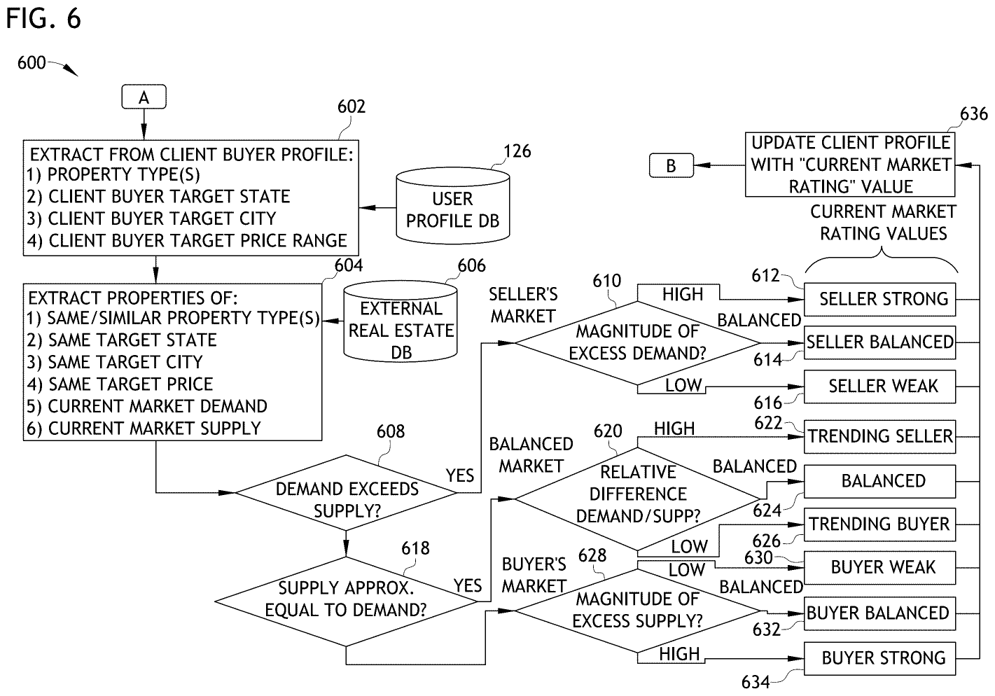

FIG. 6 illustrates a schematic logical diagram 600 of a method of determining and assigning a current market rating value for a buyer client within the schematic logical diagram of the method of creating the buyer client profile record of FIG. 5. The buyer's client profile is updated with a “current market rating” value 636 from collection and input of data from databases (126, 606) and making decisions on supply and demand (608, 610, 618, 620, 628) and the strength and weaknessess of buyers and sellers (612 through 634).

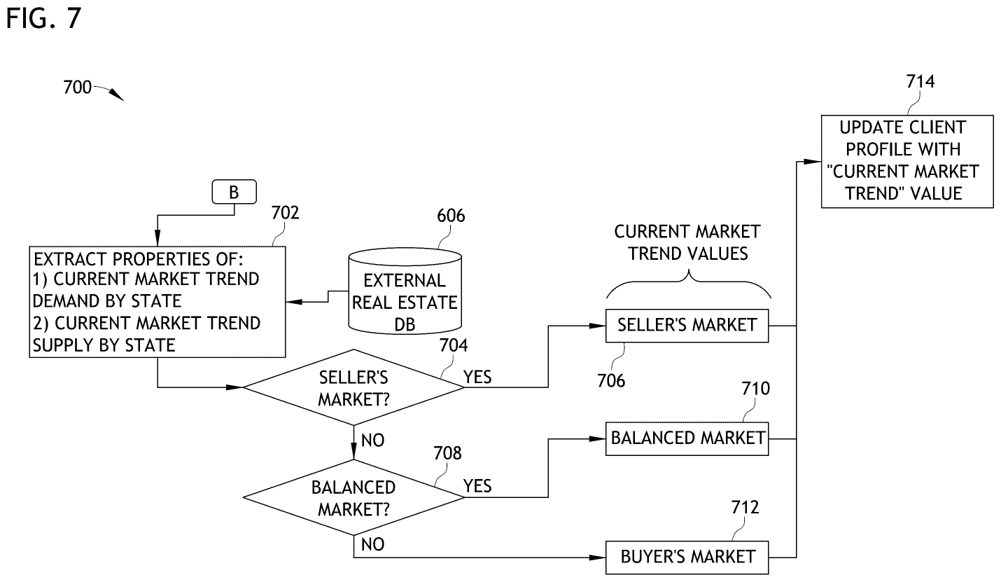

FIG. 7 illustrates a schematic logical diagram 700 of a method of determining and assigning a current market trend value for either a buyer client or a seller client within the schematic logical diagram of the method of creating both the buyer profile record and the seller profile record of FIG. 5. The client profile is updated with a “current market trend” value 714 from collection and input of data from databases (606, 702) and making decisions on trends (704, 708) and the trends in the market (706, 710, 712).

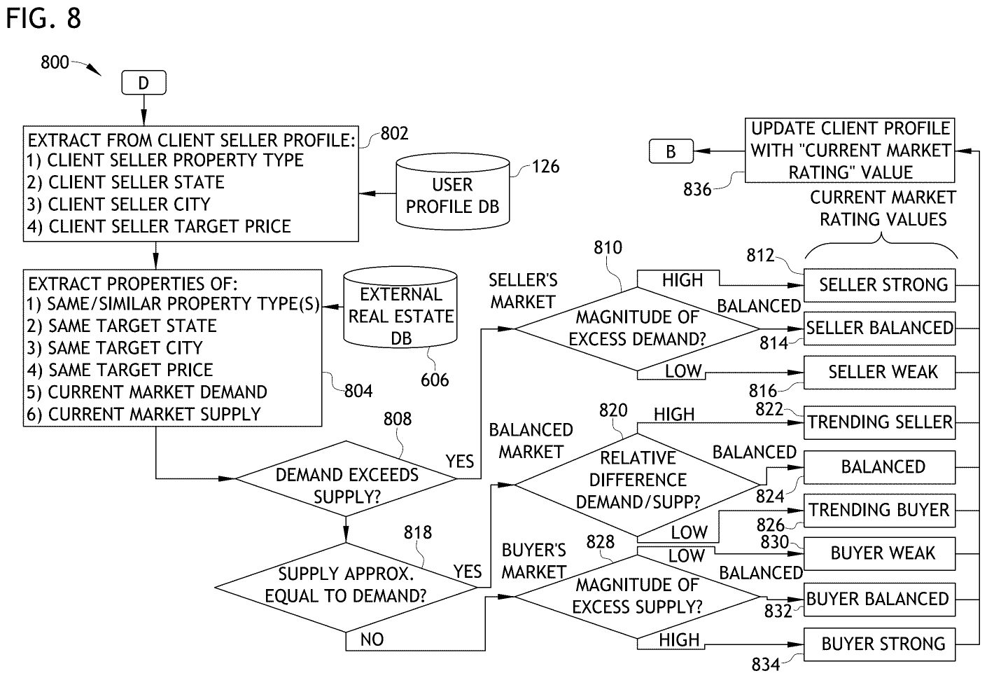

FIG. 8 illustrates a schematic logical diagram 800 of a method of determining and assigning a current market rating value for a seller client within the schematic logical diagram of the method of creating the seller client profile of FIG. 5. The client profile is updated with a “current market rating” value 836 from collection and input of data from databases (126, 606, 802, 804) and making decisions on trends (808, 818) and the trends in the market (810, 820, 828, 812 through 834).

FIG. 9 illustrates a continuation of the schematic logical diagram 900 of the method of creating both the buyer profile record and the seller profile record that will be stored in the profile database 126 of FIG. 5. The system's tasks on the buyer side (908 through 924) as well as the seller side (928 through 940) are shown. In embodiments using the open-access engagement tools and taking a privacy centric approach, certain client personal information is not taken or recorded (e.g., contact information), at least initially, instead focusing the process on user input preferences, such as budget, location, property type, etc., as explained further above.

### User Profiles: Exemplary Buyer Client User Profile

FIG. 10 illustrates an exemplary buyer client profile record 1000 created by the method of FIGS. 5-7 and 9, with types of information that may be input and collected or system populated (01 through 31).

FIG. 11 illustrates an exemplary seller client profile record 1100 created by the method of FIGS. 5 and 7-9, with types of information that may be input and collected or system populated (01 through 31).

### User Interfaces: Buyer Agent User Interface

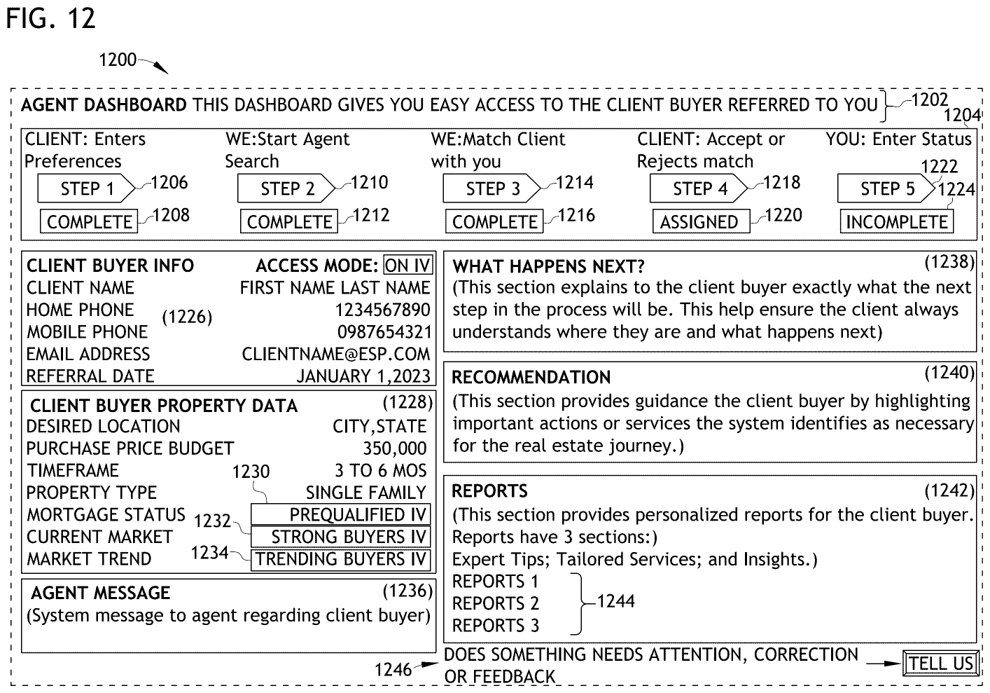

FIG. 12 illustrates a buyer agent user interface 1200. Sections of the Agent Dashboard 1202 include progress on steps taken 1204 (1206 through 1224), Client Buyer Info 1226, Client Buyer Property Data 1228, Agent Message 1236, What Happens Next? 1238, Recommendation 1240, Reports 1242, 1244, and whether something needs attention 1246.

### User Interfaces: Seller Agent User Interface

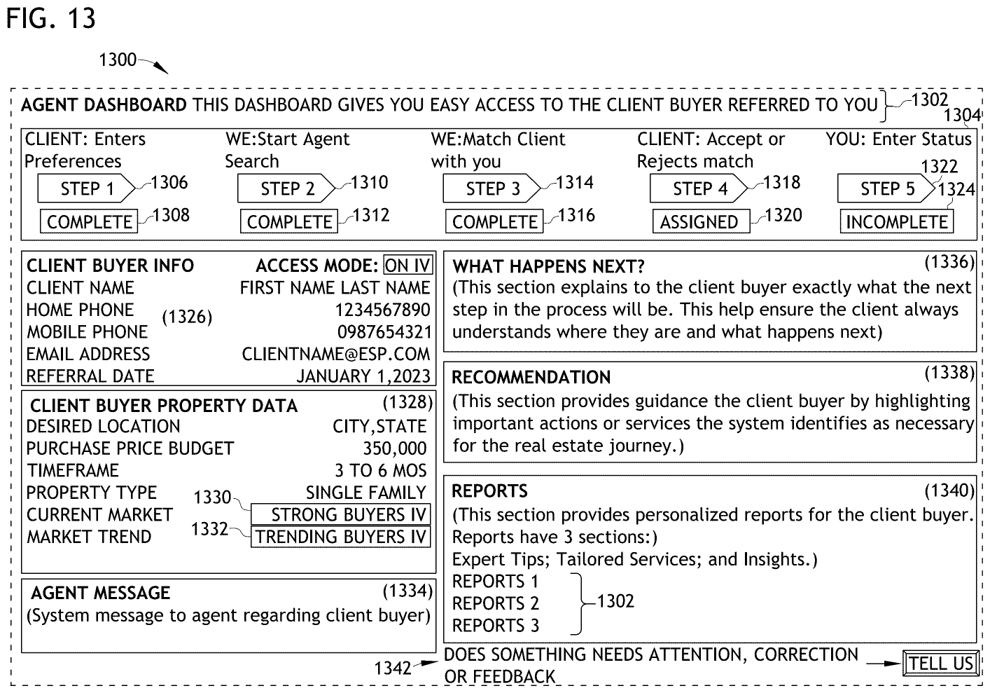

FIG. 13 illustrates a seller agent user interface 1300. Sections of the Agent Dashboard 1302 include progress on steps taken 1304 (1306 through 1324), Client Seller Info 1326, Client Seller Property Data 1328, Agent Message 1334, What Happens Next? 1336, Recommendation 1338, Reports 1340, 1302, and whether something needs attention 1342.

### User Interfaces: Buyer Client User Interface

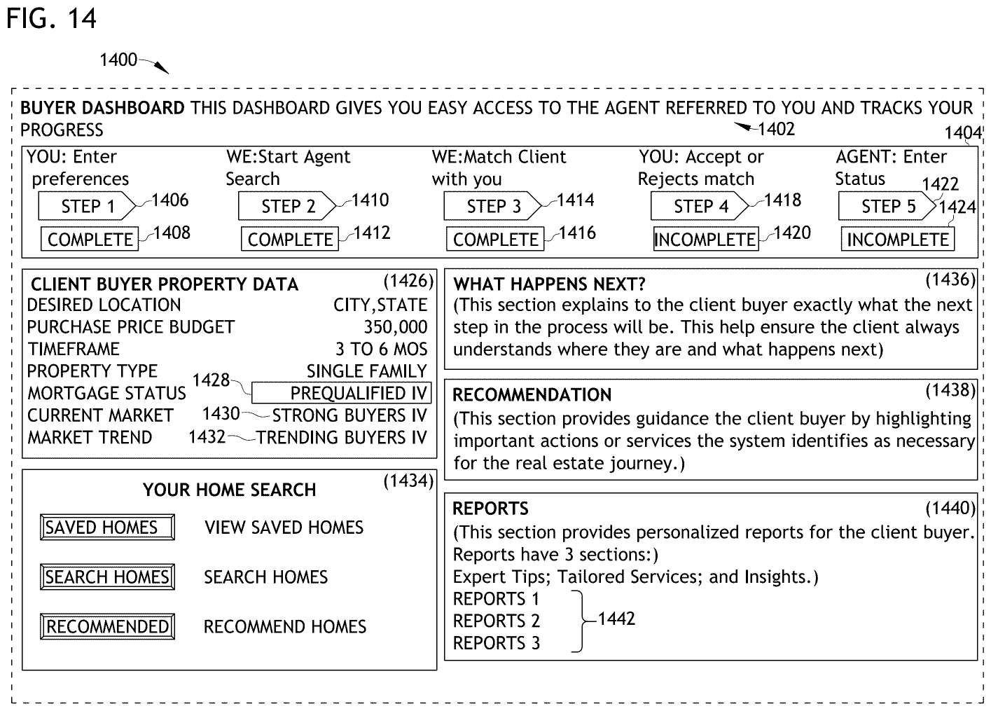

FIG. 14 illustrates a buyer client user interface 1400. Sections of the Buyer Dashboard 1402 include progress on steps taken 1404 (1406 through 1424), Your Information 1426, Your Home Search 1434, What Happens Next? 1436, Recommendation 1438, and Reports 1440, 1442.

### User Interfaces: Seller Client User Interface

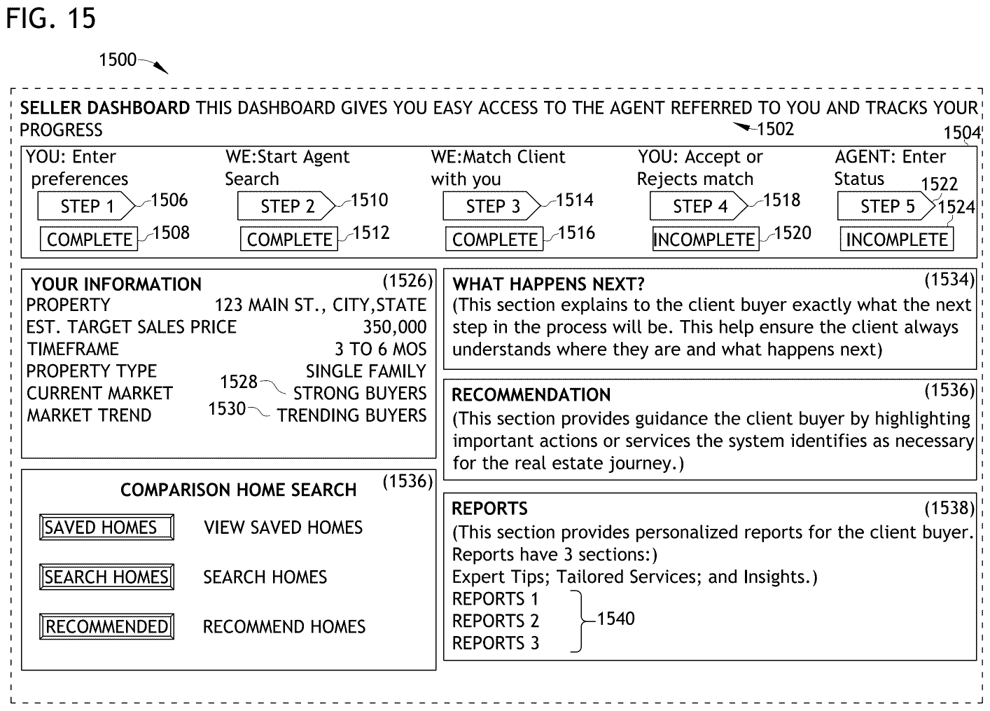

FIG. 15 illustrates a seller client user interface 1500. Sections of the Seller Dashboard 1502 include progress on steps taken 1504 (1506 through 1524), Your Information 1526, Comparison Home Search 1532, What Happens Next? 1534, Recommendation 1536, and Reports 1538, 1540.

### User Interfaces: Client Agent Rating and Performance User Interface

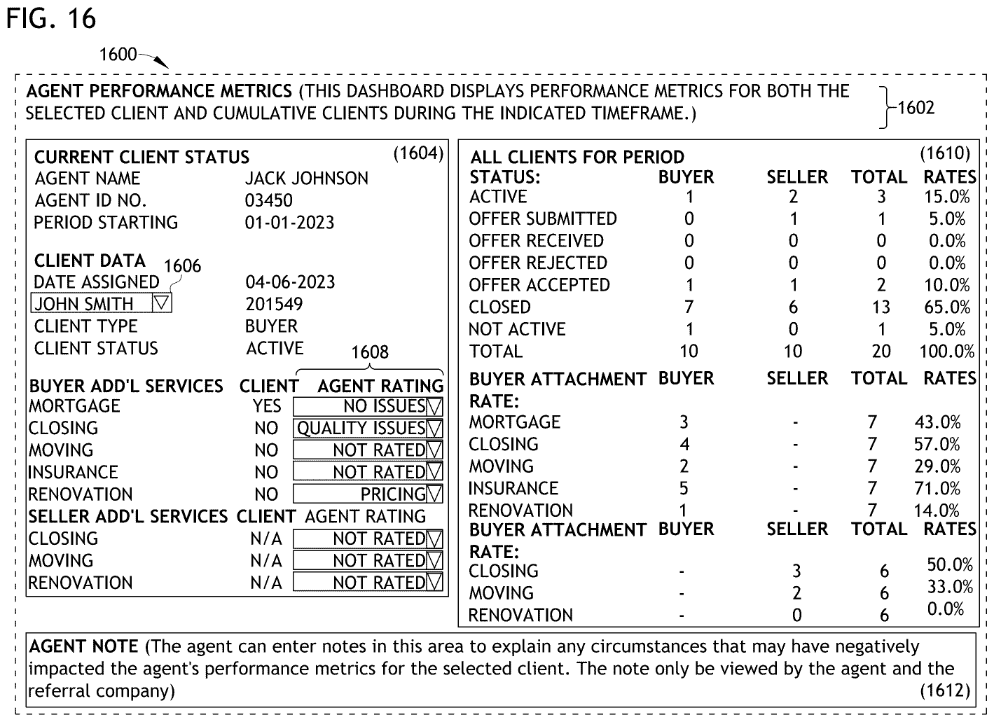

FIG. 16 illustrates an agent rating and performance metrics user interface 1600. Sections of the Agent Performance Metrics (dashboard) 1602 include Current Client Status and Client Data 1604 as well as Buyer Add'l Services and Seller Add'l Services and Agent Rating 1608. Additional sections include All Clients For Period 1610 data and an Agent Note 1612 field.

### User Interfaces: Additional Client Services Provider User Interface

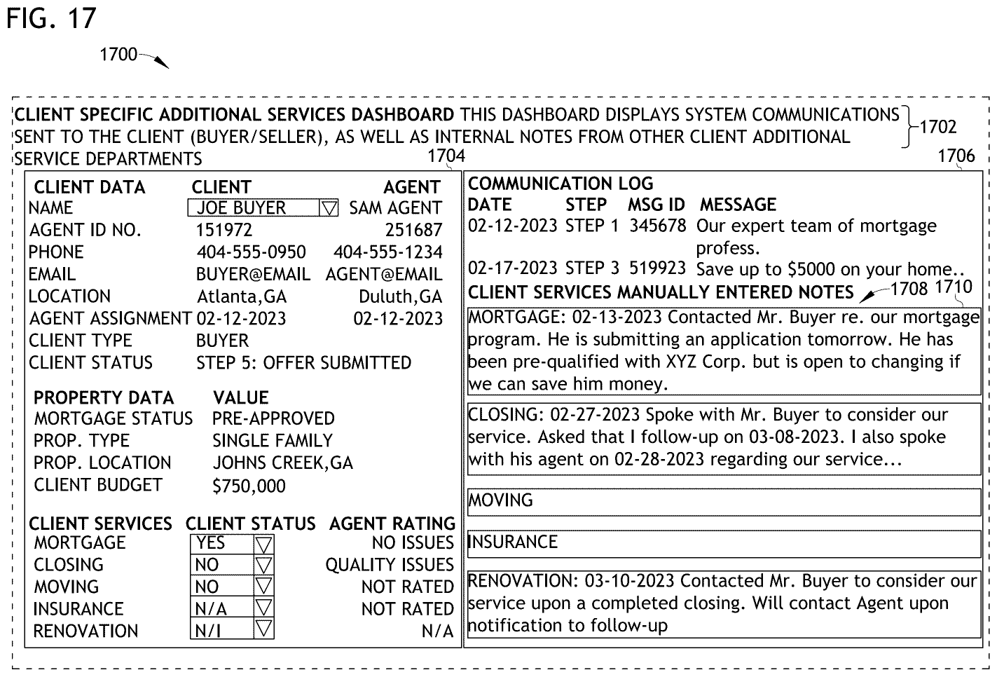

FIG. 17 illustrates an additional client services provider user interface 1700. Sections of the Client Specific Additional Services Dashboard 1702 include Client Data/Client/Agent, Property Data/Value, and Client Services/Client Status/Agent Rating 1704, as well as a Communication Log 1706 and Client Services Manually Entered Notes 1708, 1710.

### User Interfaces: Additional Client Services Provider Cumulative Ratings User Interface

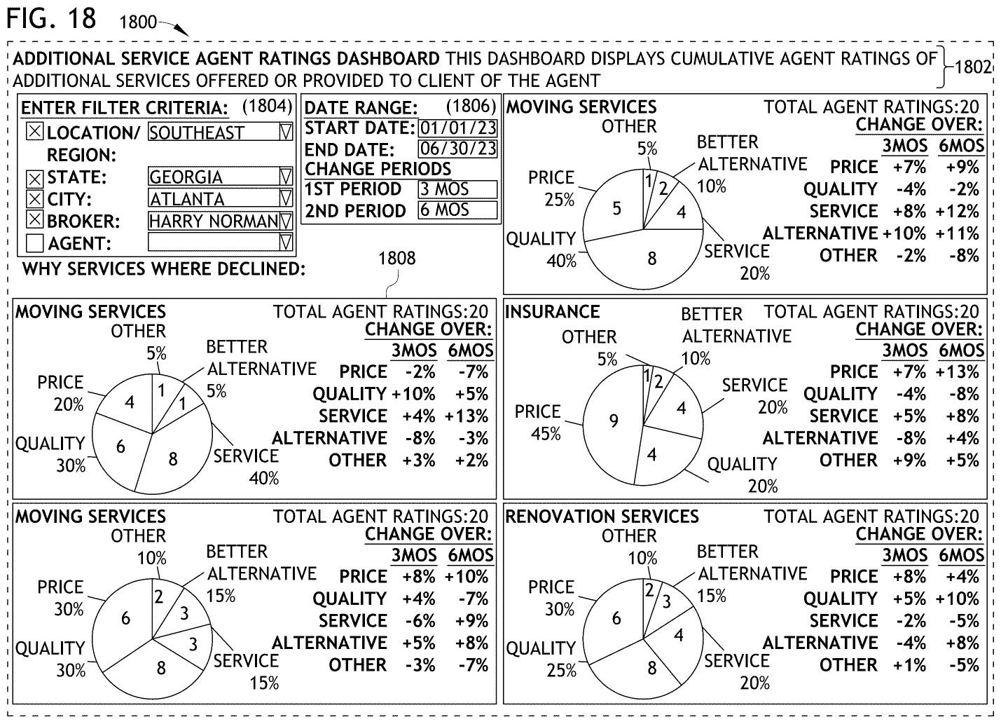

FIG. 18 illustrates an additional client services provider cumulative ratings user interface 1800. Sections of the Additional Services Agent Ratings Dashboard 1802 include Filter Cirteria 1804 and Date Range 1806, Why Services Were Declined 1808 (Mortgage Services 1810, Closing Services 1812, Moving Services 1814, Insurance 1816, and Renovation Services 1818).

### Messages: Building a Message Record

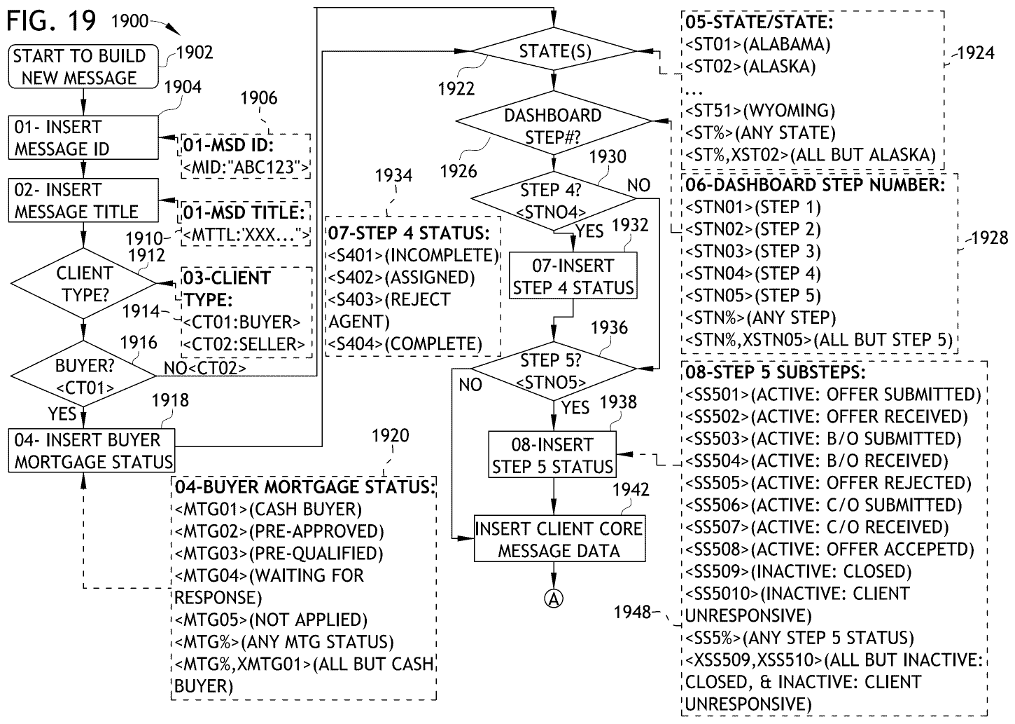

FIG. 19 illustrates a schematic logical diagram 1900 of a first embodiment of a method of building a message record that is stored in a message database. The types of information that is collected and input is shown (e.g., steps 01 through 08) as well as decisions (1912, 1916, 1922, 1926, 1930, 1936) are shown.

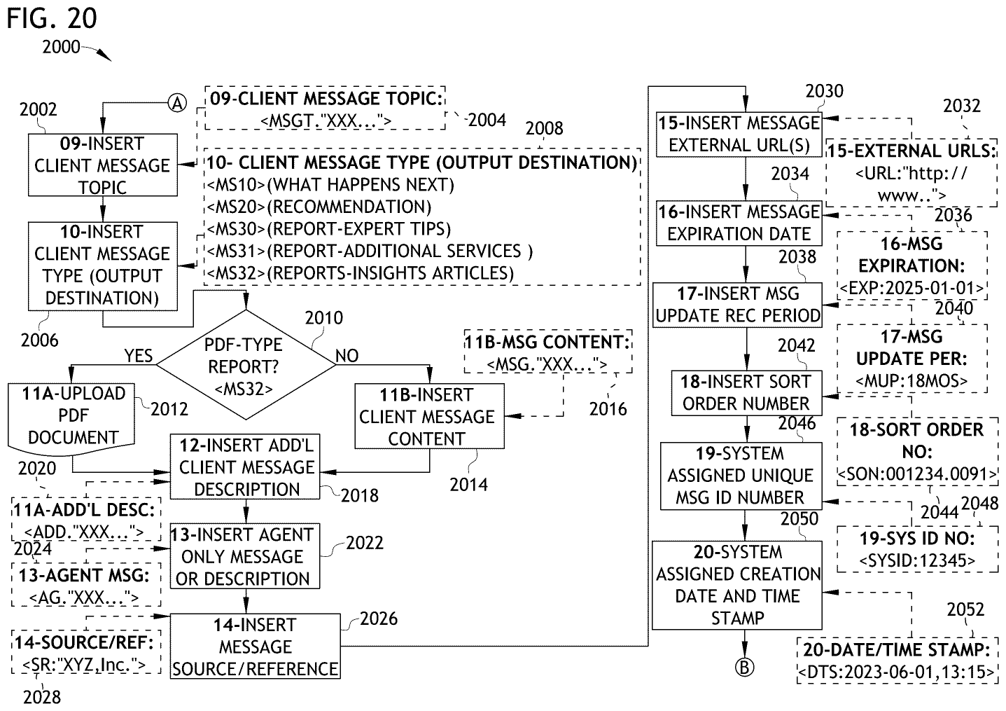

FIG. 20 illustrates a continuation of the schematic logical diagram 2000 of the first embodiment of the method of building the message record of FIG. 19. Steps 09 through 20 are shown.

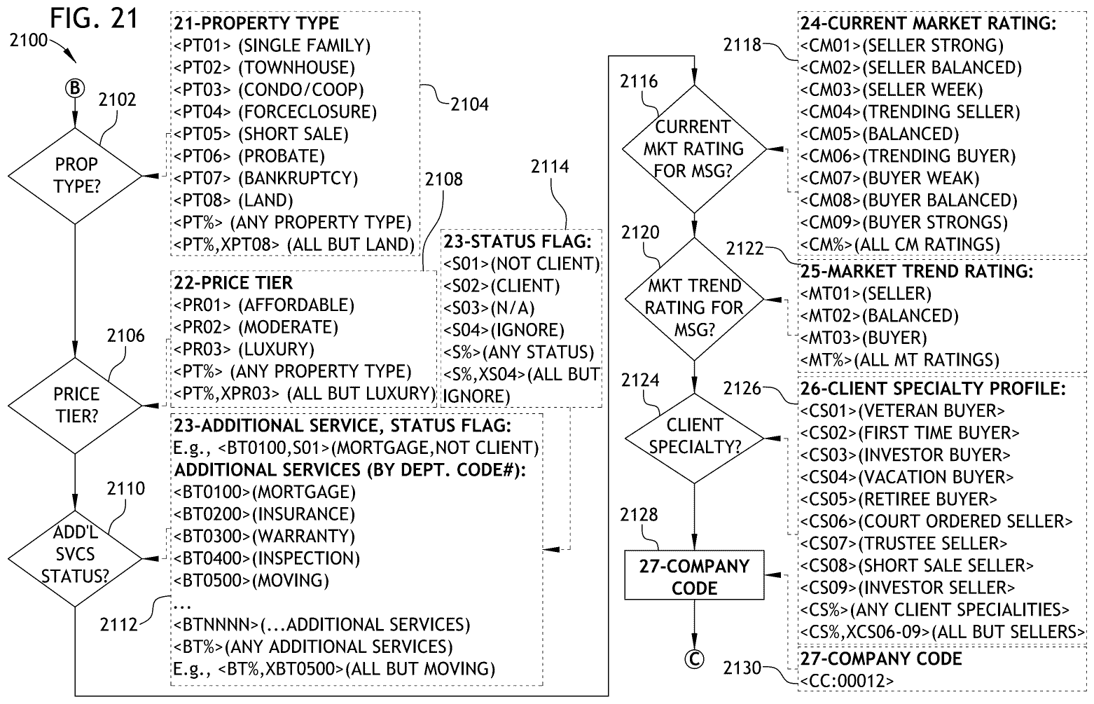

FIG. 21 illustrates a further continuation of the schematic logical diagram 2100 of the first embodiment of the method of building the message record of FIGS. 19-20. Steps 21 through 27 are shown.

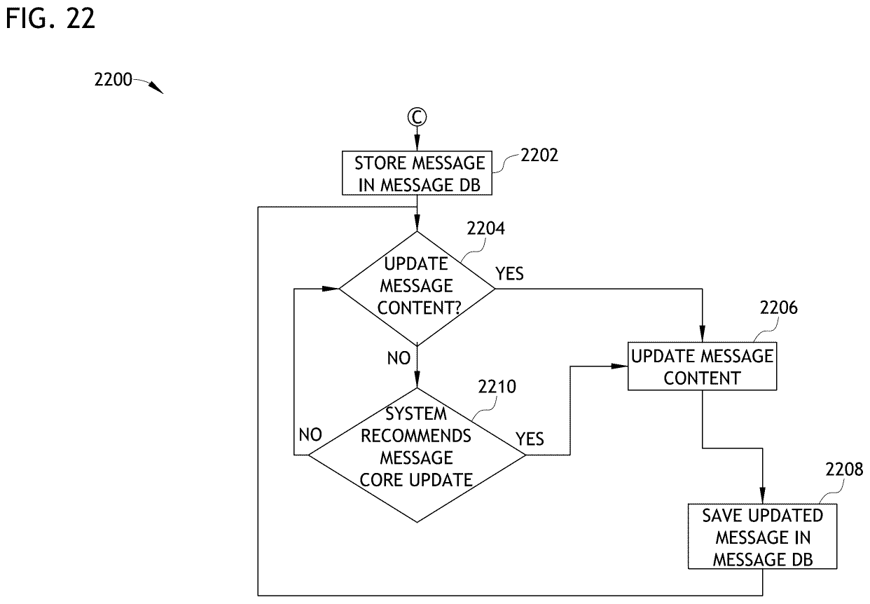

FIG. 22 illustrates a further continuation of the schematic logical diagram 2200 of the first embodiment of the method of building the message record of FIGS. 19-21. The storage of the message in the database 2202 and updating 2204, 2206, 2208, 2210 of such is shown.

### Messages: Exemplary Message Record

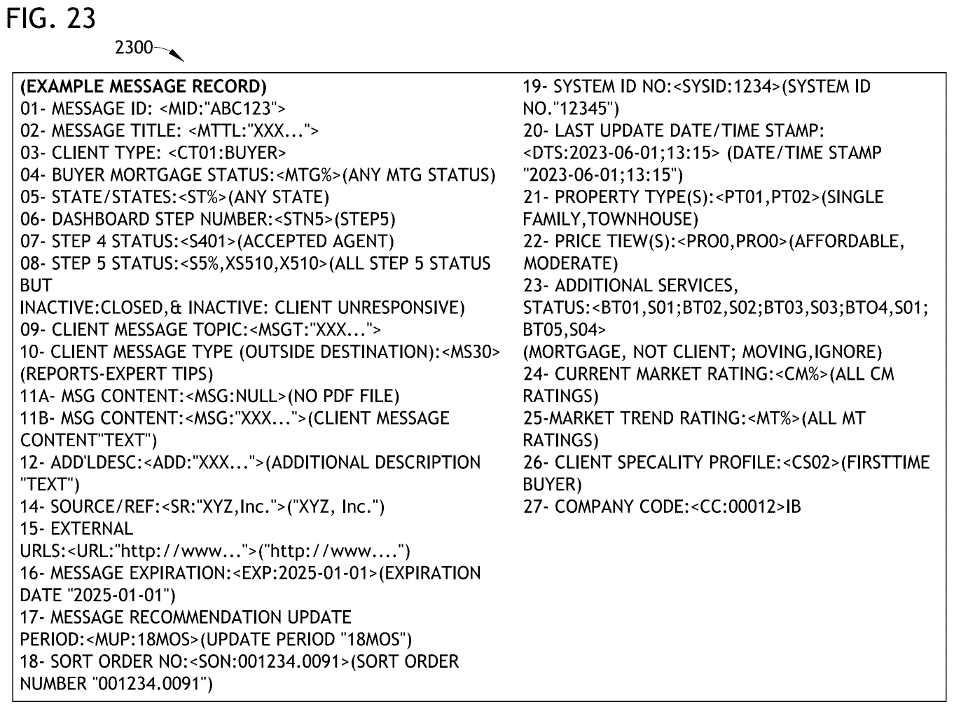

FIG. 23 illustrates an exemplary message record 2300 created by the method of FIGS. 19-22, with types of information that may be input and collected (01 through 27).

### Messages: Message Record Distribution

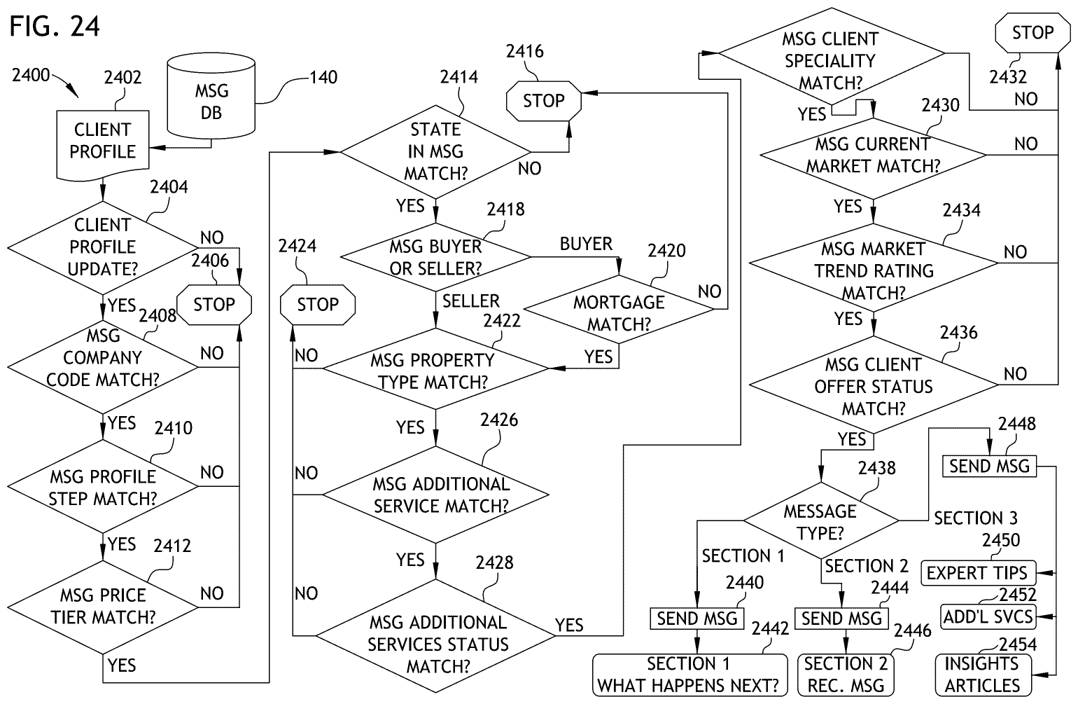

FIG. 24 illustrates a schematic logical diagram 2400 of a method of distributing a stored message record from the message database to one of the three display outputs on the buyer and seller agent user interfaces and buyer client and seller user interfaces.

### Client Real Estate Transaction Tracking on Client User Interface: Real Estate Transaction Steps 1-4

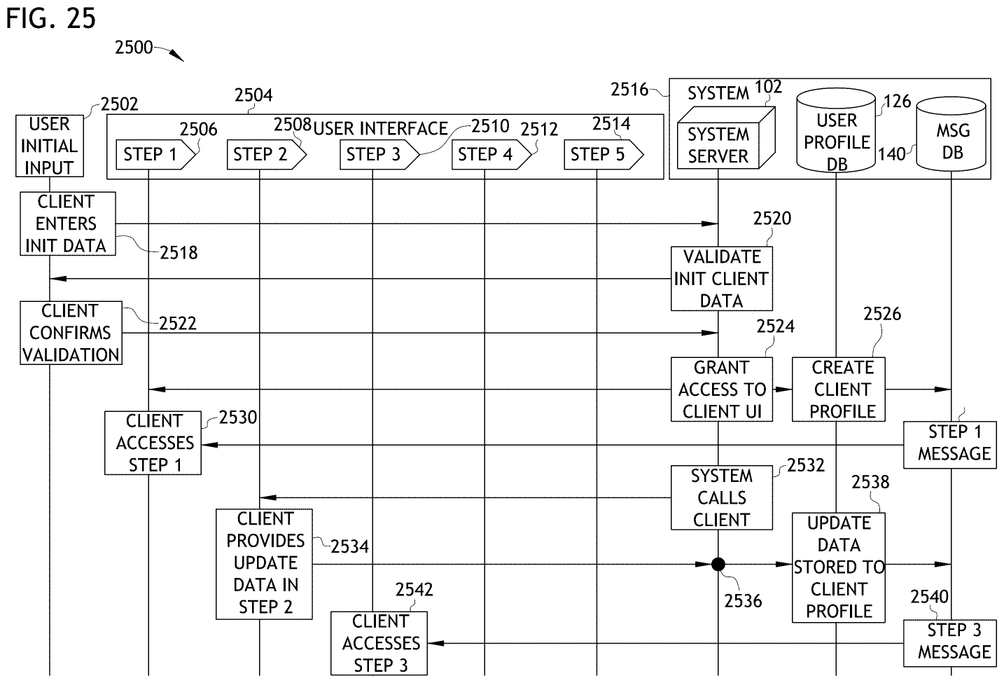

FIG. 25 illustrates a schematic workflow diagram 2500 of a method of client interaction with the system server 102 via the buyer client user interface (of FIG. 14) or the seller client user interface (of FIG. 15) 2504.

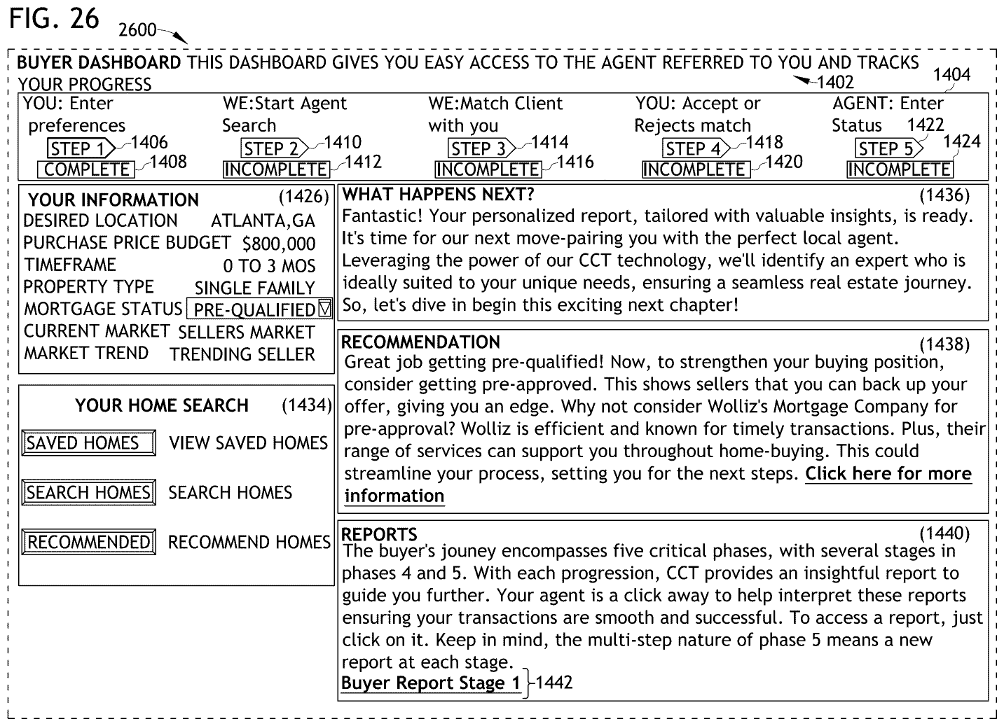

FIG. 26 illustrates an exemplary buyer client user interface 2600 at a first step of the client real estate transactions maintained by the system corresponding to the first step of the user interface 1406 in FIG. 25. The Buyer Dashboard 1402 shows Step 1 is Complete 1408.

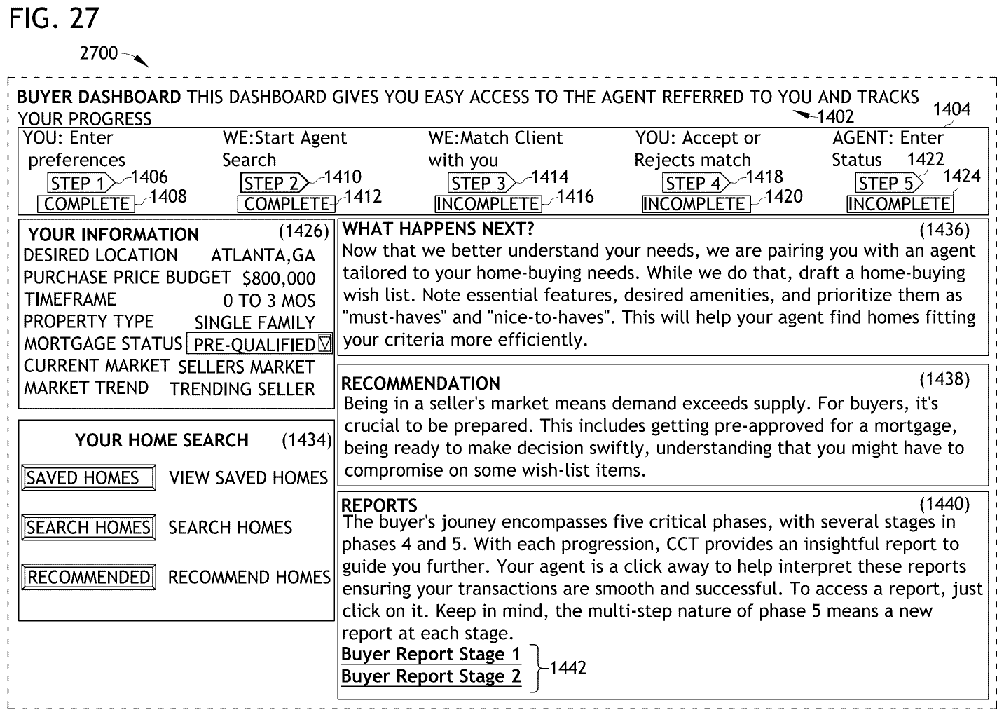

FIG. 27 illustrates an exemplary buyer client user interface 2700 at a second step of the client transactions maintained by the system corresponding to the second step of the user interface 1410 in FIG. 25. The Buyer Dashboard 1402 shows Step 1 is Complete 1408 and Step 2 is Complete 1412.

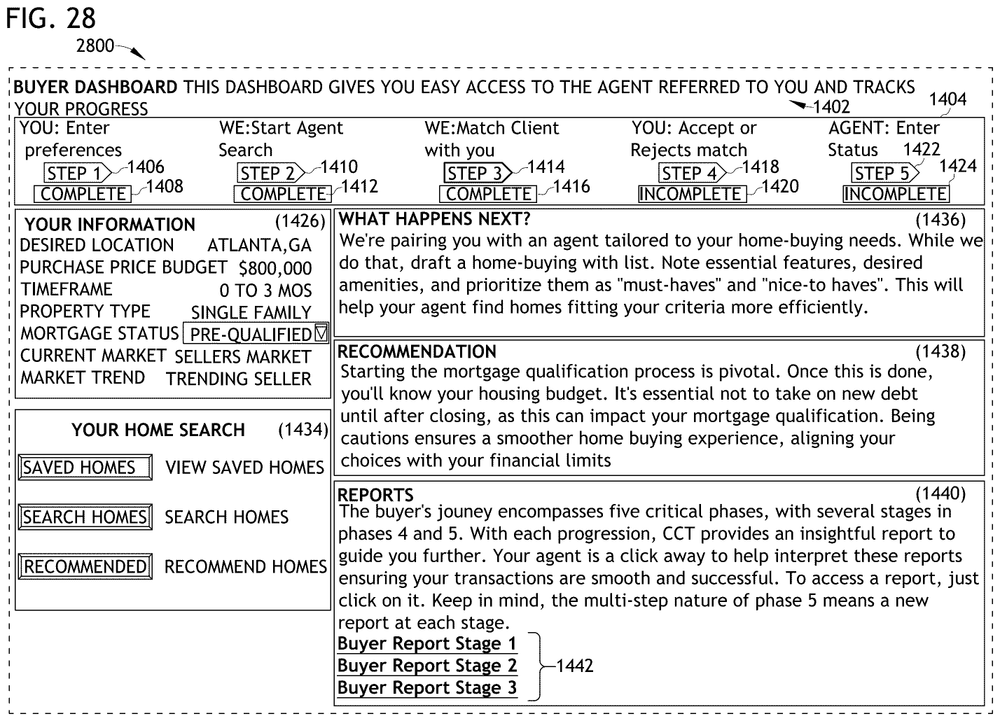

FIG. 28 illustrates an exemplary buyer client user interface 2800 at a third step of the client transactions maintained by the system corresponding to the third step of the user interface 1416 in FIG. 25. The Buyer Dashboard 1402 shows Step 1 is Complete 1408, Step 2 is Complete 1412, and Step 3 is Complete 1416.

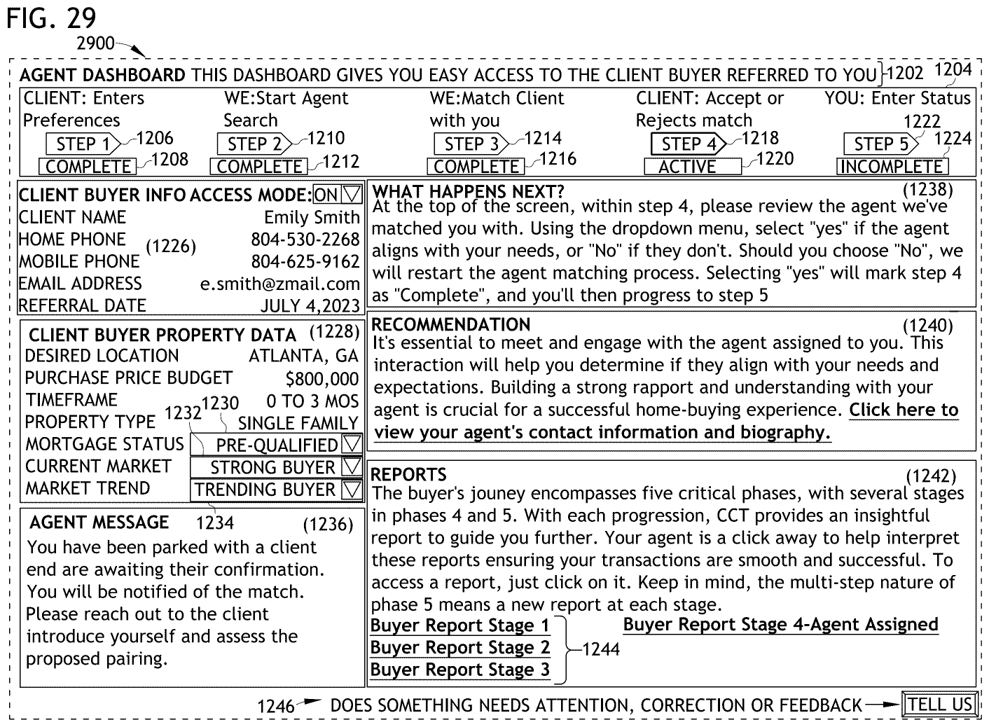

FIG. 29 illustrates an exemplary buyer agent user interface 2900 at a fourth step of the client transactions maintained by the system corresponding to the fourth step 1218 of the user interface 1220 in FIG. 25. The Agent Dashboard 1202 shows Step 1 is Complete 1208, Step 2 is Complete 1212, Step 3 is Complete 1216, and Step 4 is Active 1220.

### Client Real Estate Transaction Tracking on Client User Interface: Real Estate Transaction Step 4 Stages

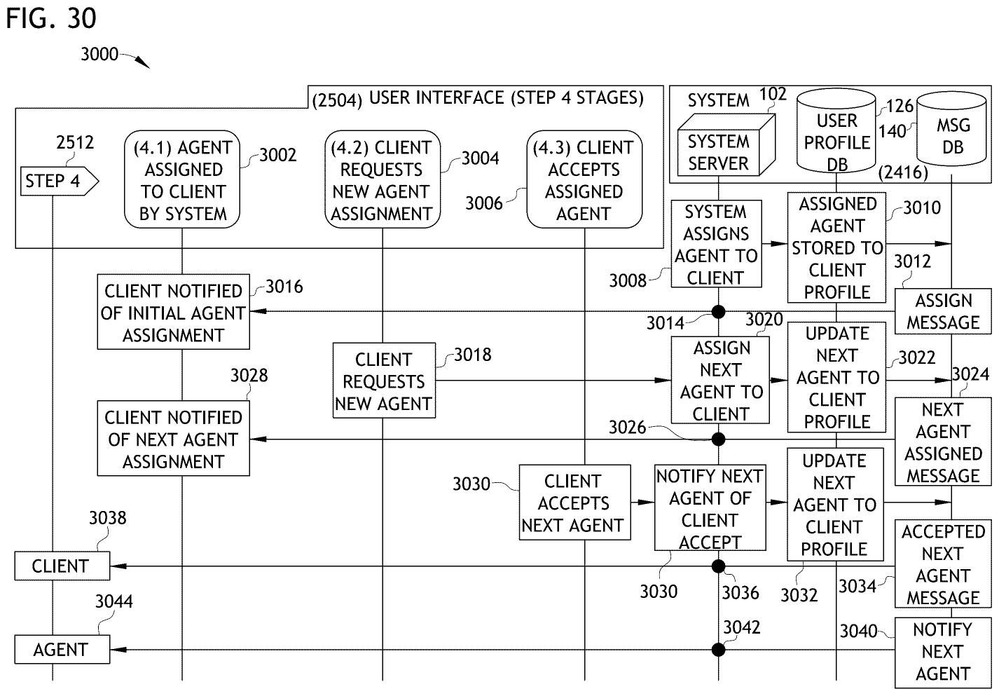

FIG. 30 illustrates a schematic workflow diagram 3000 of the method of client interaction at the fourth step with three stages with the system server via the client user interface.

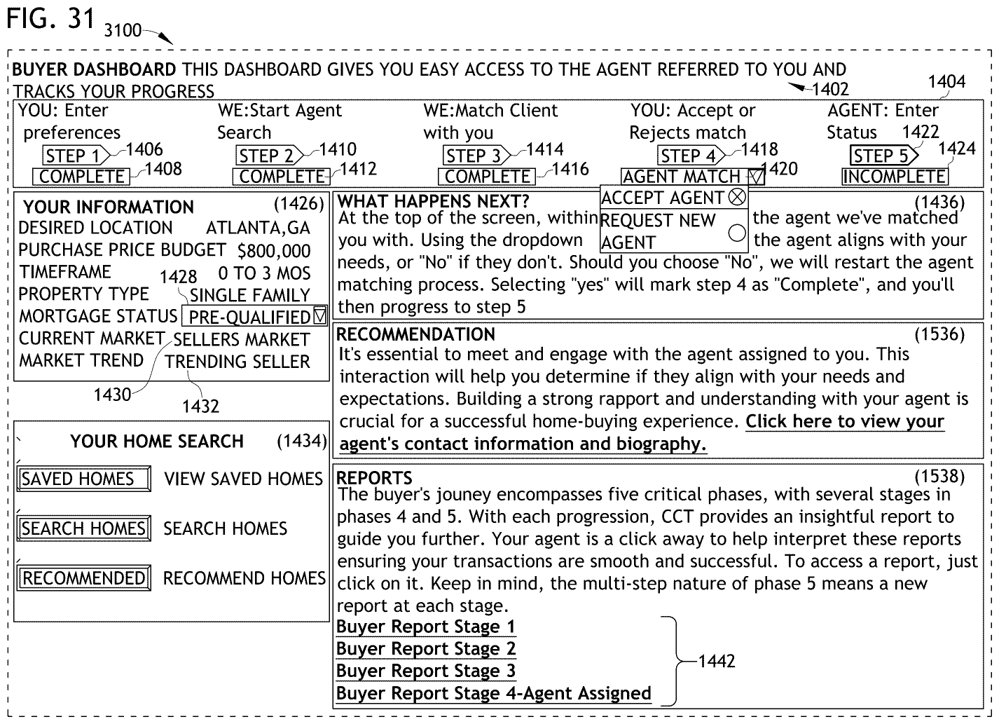

FIG. 31 illustrates an exemplary buyer client at a third stage 3102 of the fourth step 1418 of the client transactions maintained by the system 3100 corresponding to the fourth step of the user interface in FIG. 29.

### Client Real Estate Transaction Tracking on Client User Interface: Real Estate Transaction Step 5

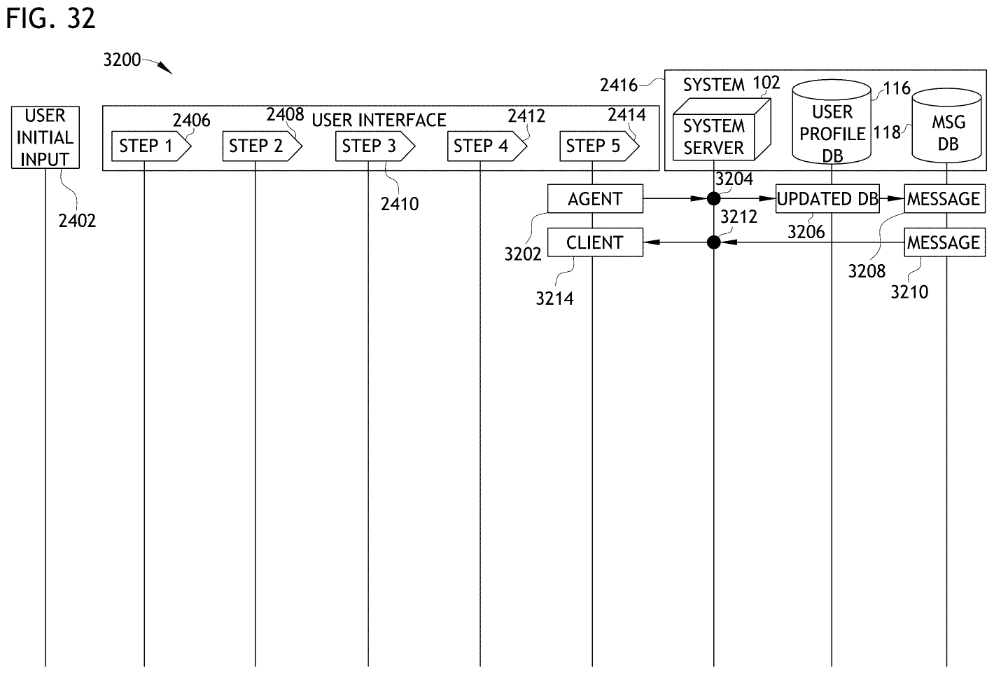

FIG. 32 illustrates a schematic workflow diagram 3200 of the method of agent interaction at the fifth step 2414 with the system server 102 via the agent user interface and the client user interface.

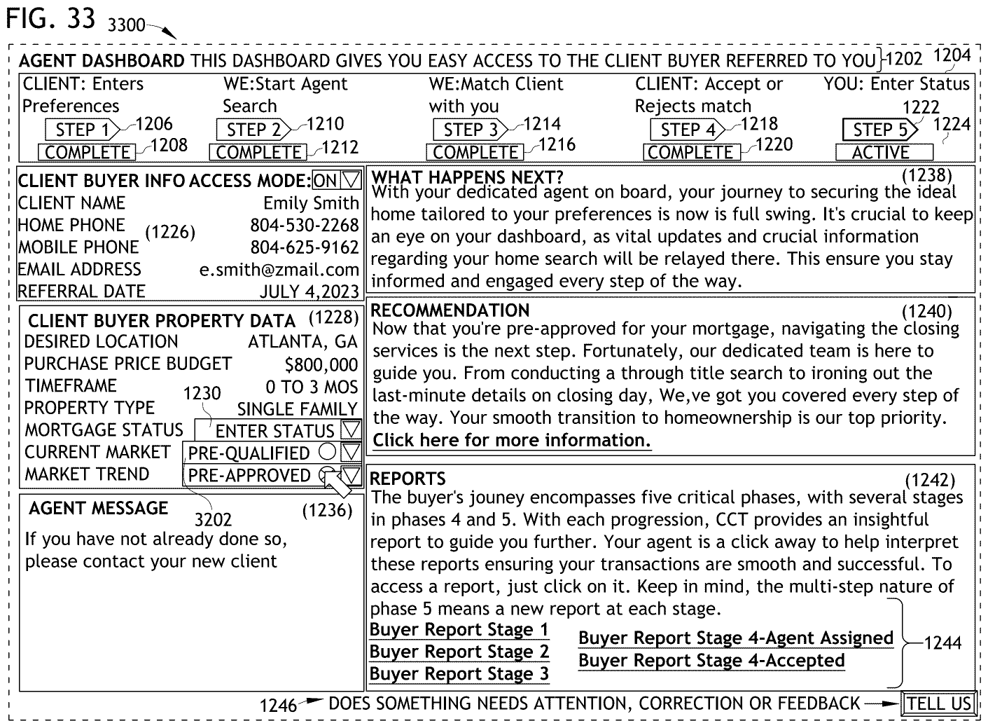

FIG. 33 illustrates an exemplary agent user interface 3300 of a method of a buyer agent updating a mortgage status of the buyer client 3202 according to FIG. 32.

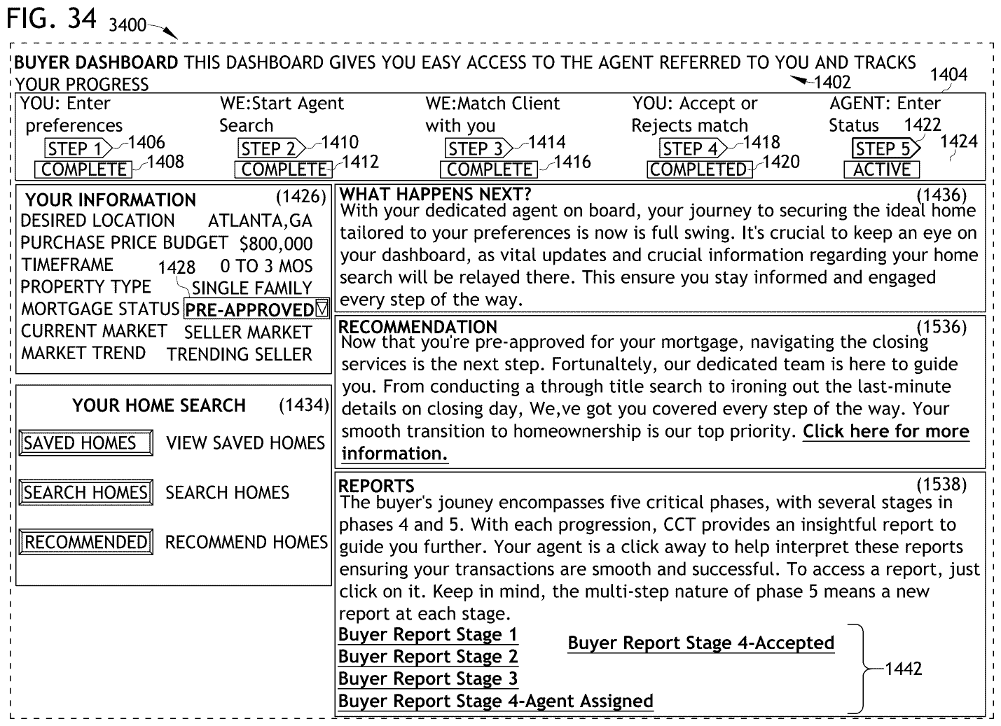

FIG. 34 illustrates an exemplary buyer client user interface 3400 updated in accordance with the action of the buyer agent updating the mortgage status of the buyer client 1428 according to FIG. 32.

### Client Real Estate Transaction Tracking on Client User Interface: Real Estate Transaction Step 5 Stages

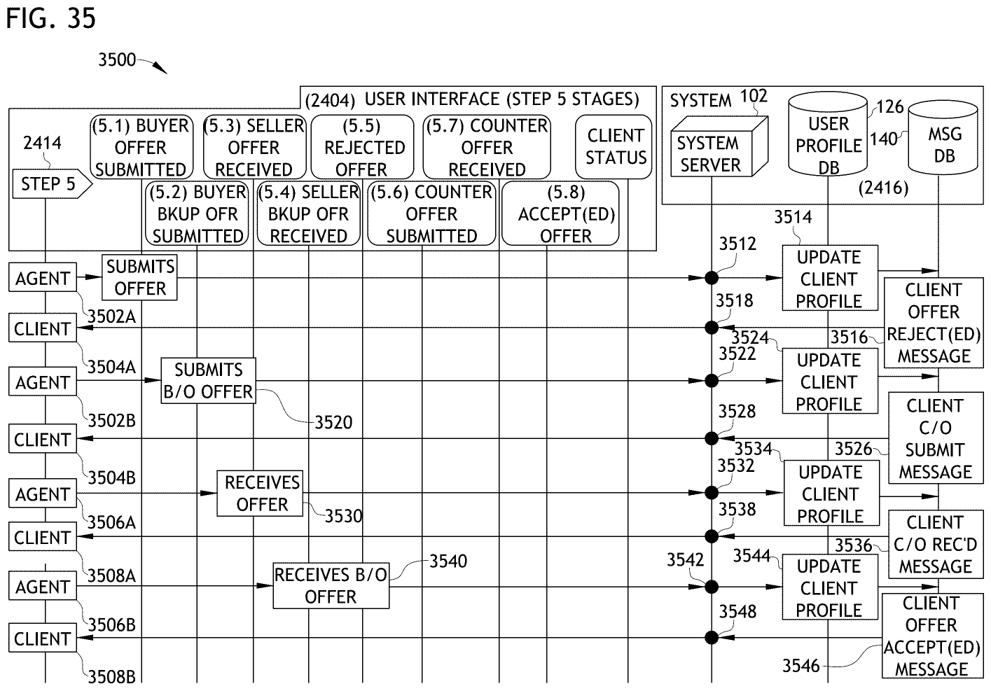

FIG. 35 illustrates a schematic workflow diagram 3500 of a method of client and agent interaction at the fifth step including eight stages and a client status stage with the system server via the buyer client or seller client user interface.

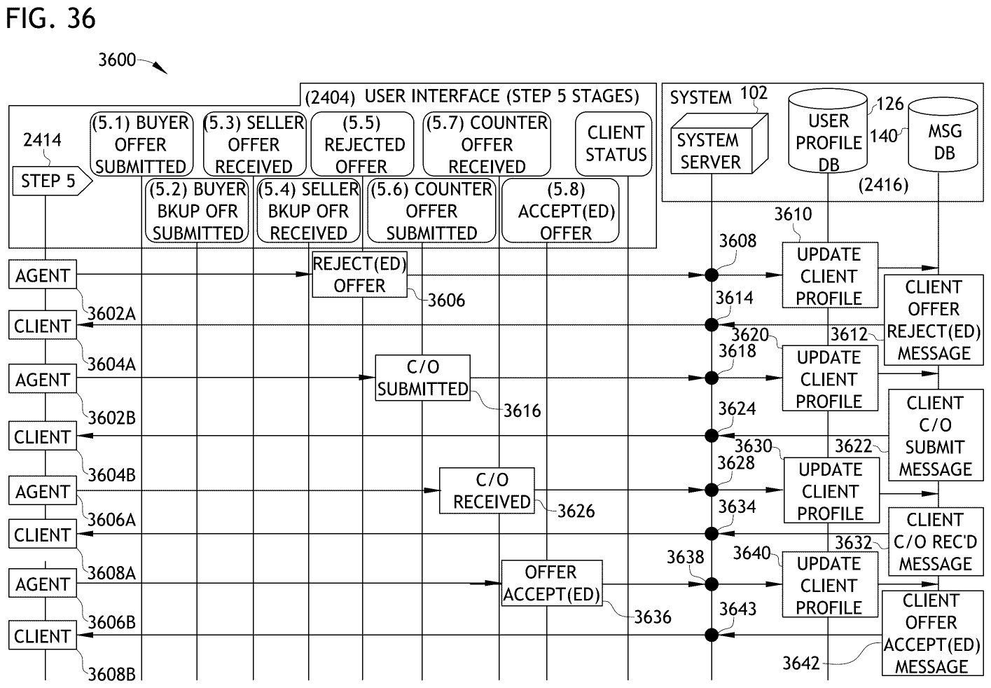

FIG. 36 illustrates continuation of the schematic workflow diagram 3600 of FIG. 35 of the method of client and agent interaction at the fifth step including eight stages and a client status stage with the system server via the buyer client or seller client user interface.

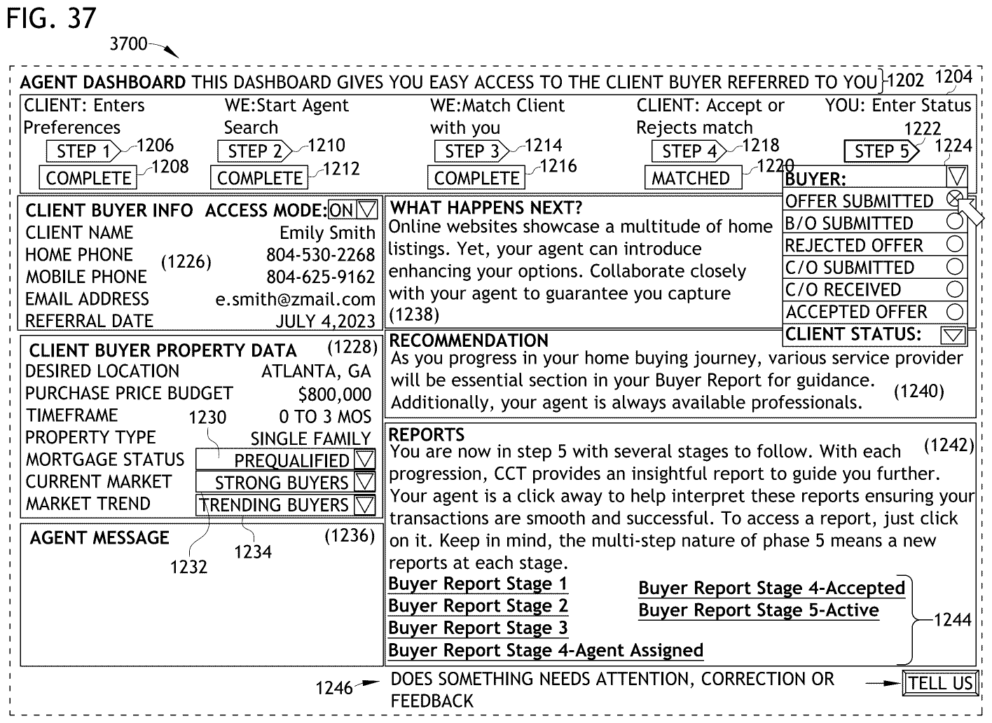

FIG. 37 illustrates an exemplary buyer agent user interface 3700 of a method of the buyer agent selecting a buyer client stage 1224.

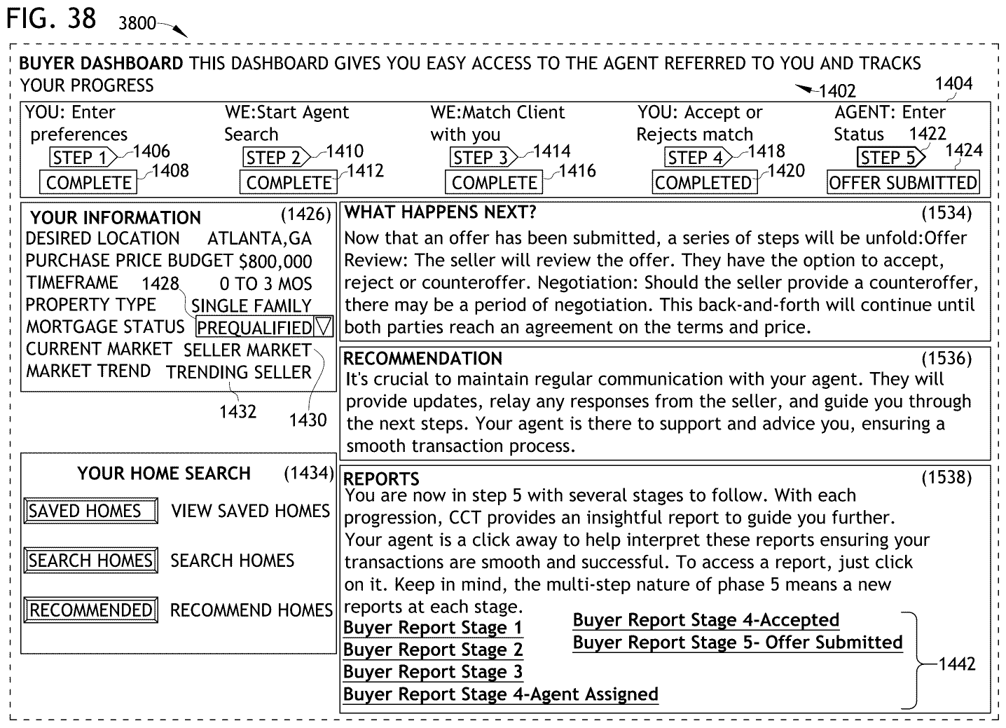

FIG. 38 illustrates an exemplary buyer client user interface 3800 of the method of FIG. 37 indicating the selection of the buyer agent on the buyer agent user interface 1424.

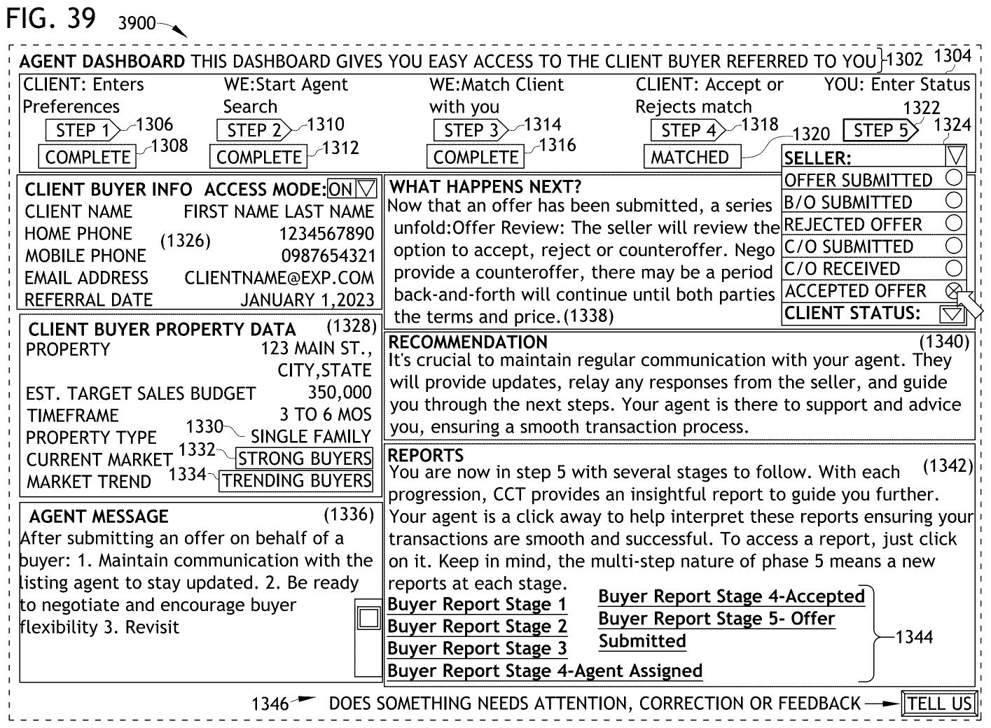

FIG. 39 illustrates an exemplary seller agent user interface 3900 of a method of the seller agent selecting a seller client stage 1324.

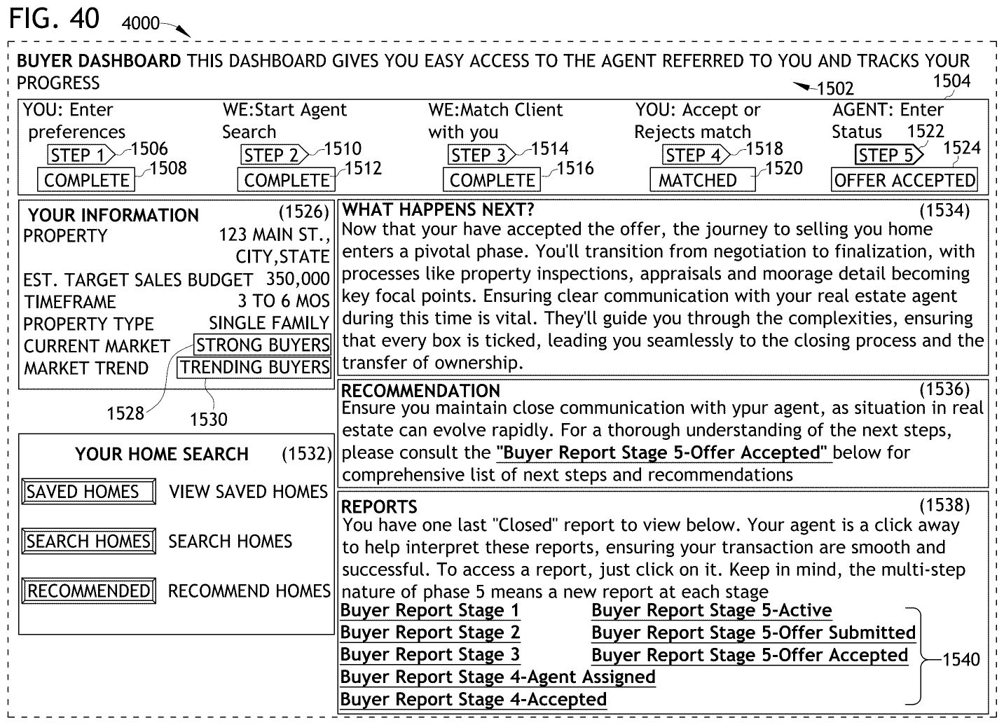

FIG. 40 illustrates an exemplary seller client user interface 4000 of the method of FIG. 39 indicating the selection of the seller agent on the seller agent user interface 1524.

### Client Real Estate Transaction Tracking on Client User Interface: Real Estate Transaction Step 5 Client Status

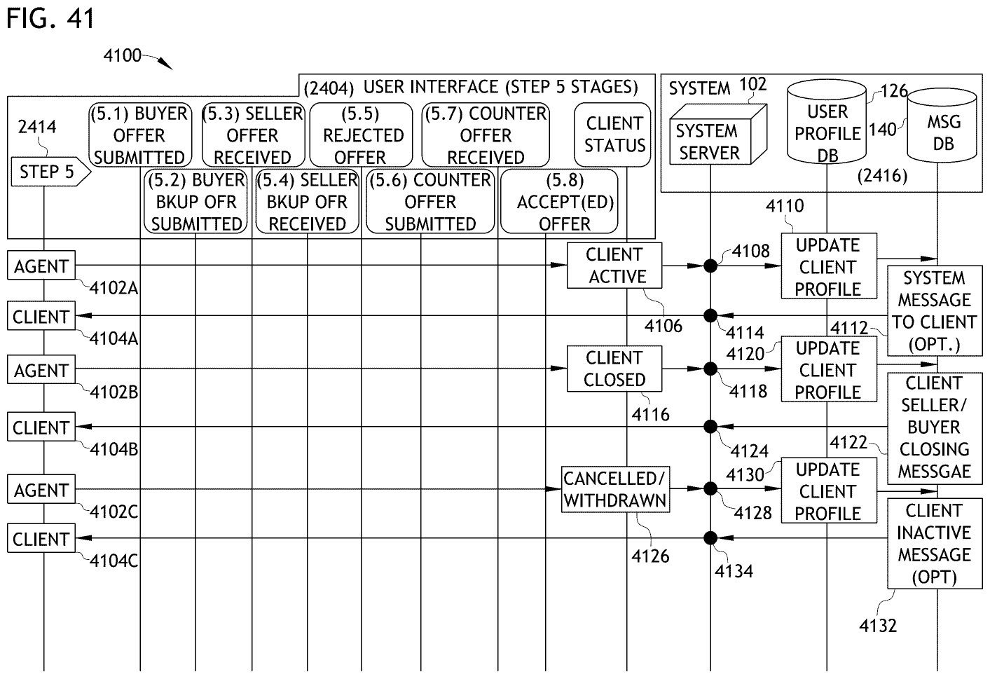

FIG. 41 illustrates continuation of the schematic workflow diagram 4100 of FIGS. 34-35 of the method of client and agent interaction at the fifth step including a client status indicator with the system server via the buyer client or seller client user interface.

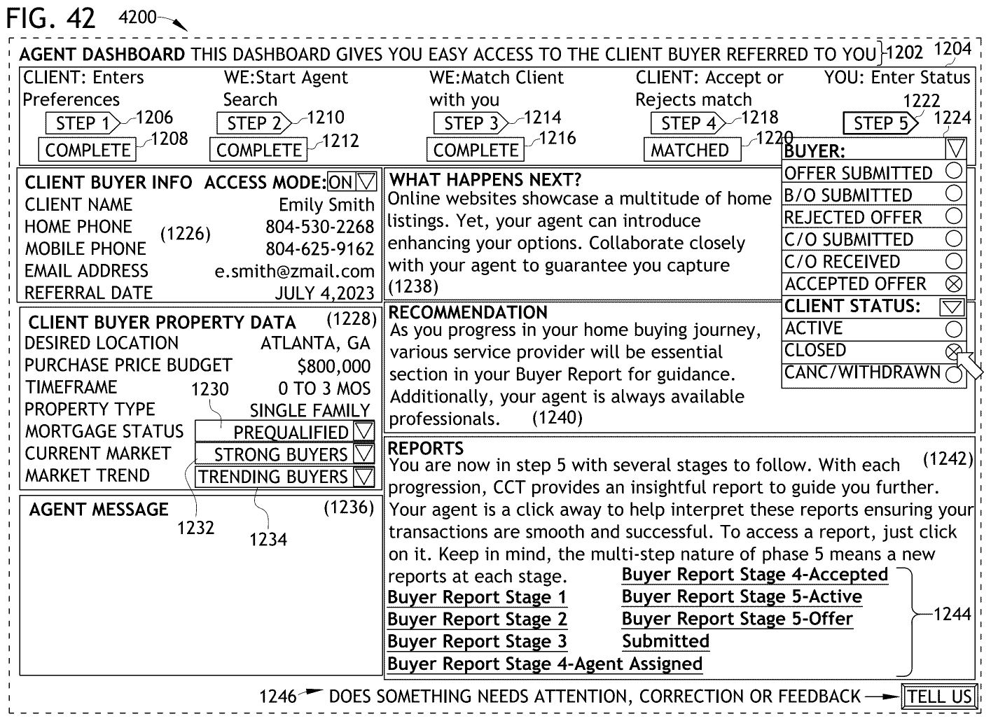

FIG. 42 illustrates an exemplary buyer agent user interface 4200 of a method of the buyer agent selecting a buyer client status 1224.

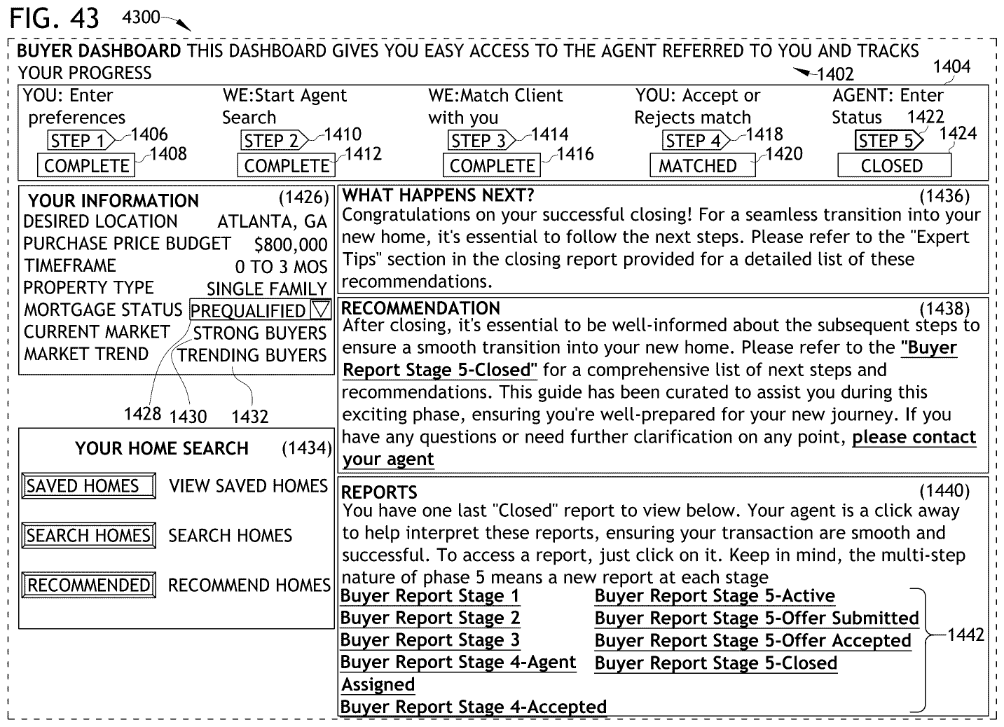

FIG. 43 illustrates an exemplary buyer client user interface 4300 of the method of FIG. 41 indicating the selection of the buyer agent of the buyer client status on the buyer agent user interface 1424.

### Exemplary Report

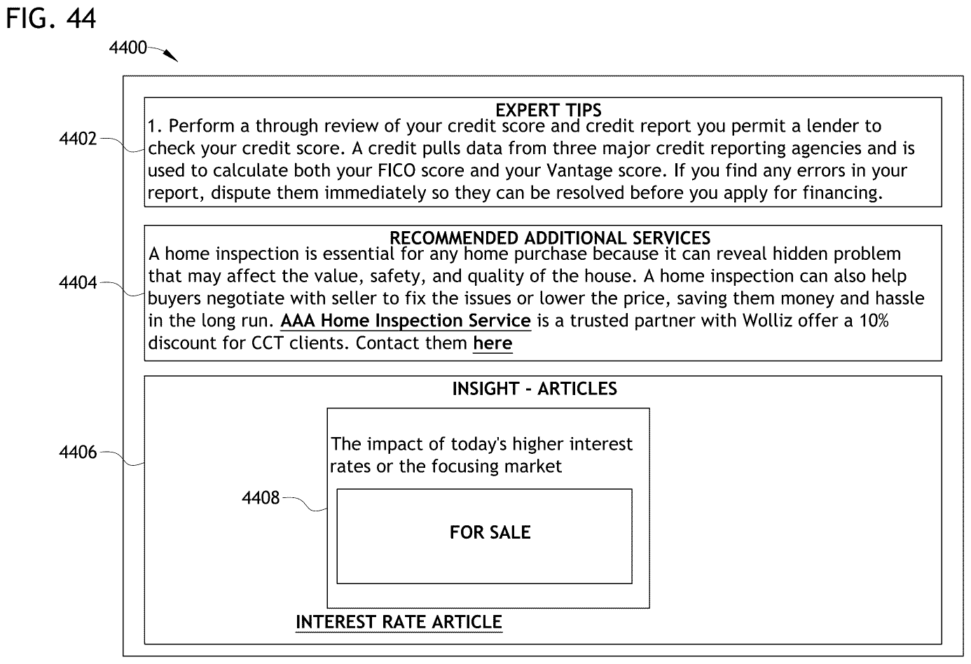

FIG. 44 illustrates an exemplary client report 4400 that includes Expert Tips 4402, Recommended Additional Services 4404, and Insights—Articles 4406, 4408.

### Client Agent Reporting User Interface: Client Agent Report Initiation

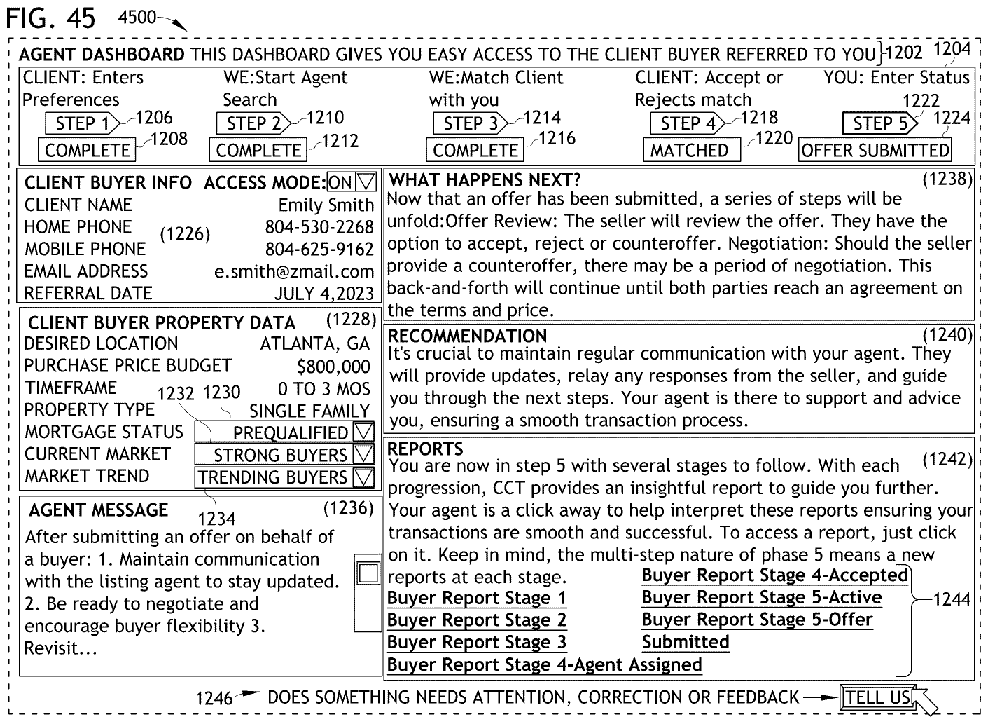

FIG. 45 illustrates an exemplary agent user interface 4500 where the agent has selected a system feedback interface element to report an issue to the system administrator 1246 (arrow).

### Client Agent Reporting User Interface: Client Agent Reporting User Interface

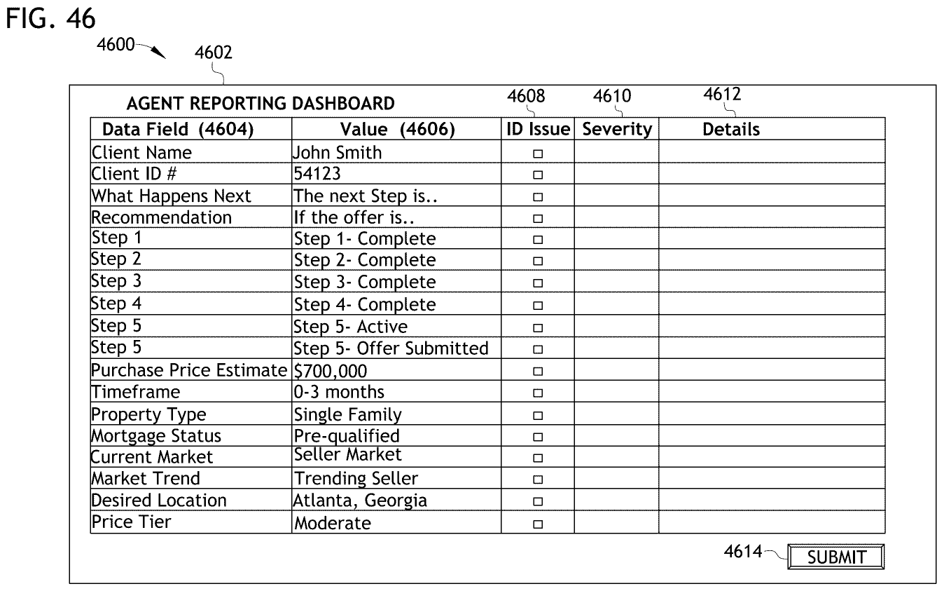

FIG. 46 illustrates an agent reporting user interface 4600 that is presented to an agent who selects the system feedback interface element of FIG. 45. This shows an Agent Reporting Dashboard 4602 with a number of fields

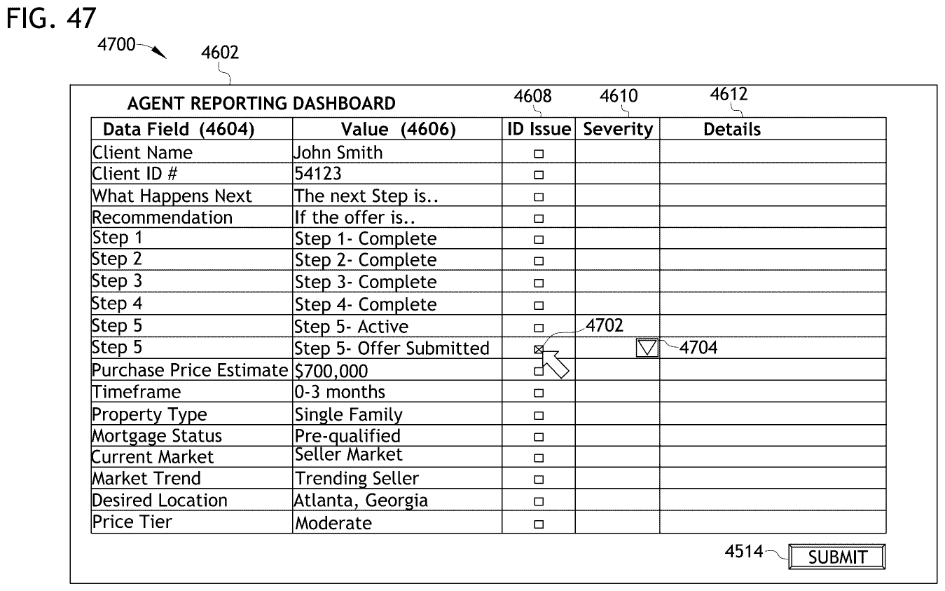

FIG. 47 illustrates the agent reporting user interface 4700 of FIG. 46 wherein the agent user has selected an ID issue corresponding to a data field and value they would like to report 4702 (arrow), 4704.

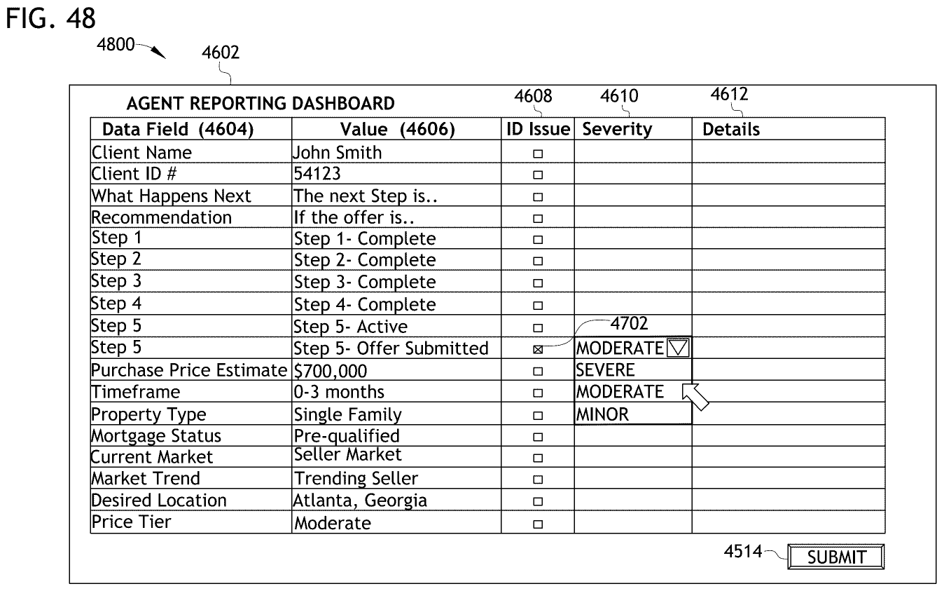

FIG. 48 illustrates the agent reporting user interface 4800 of FIGS. 46-47 wherein the agent user has selected severity value corresponding to a data field and value they would like to report 4702, 4704, 4802 (arrow).

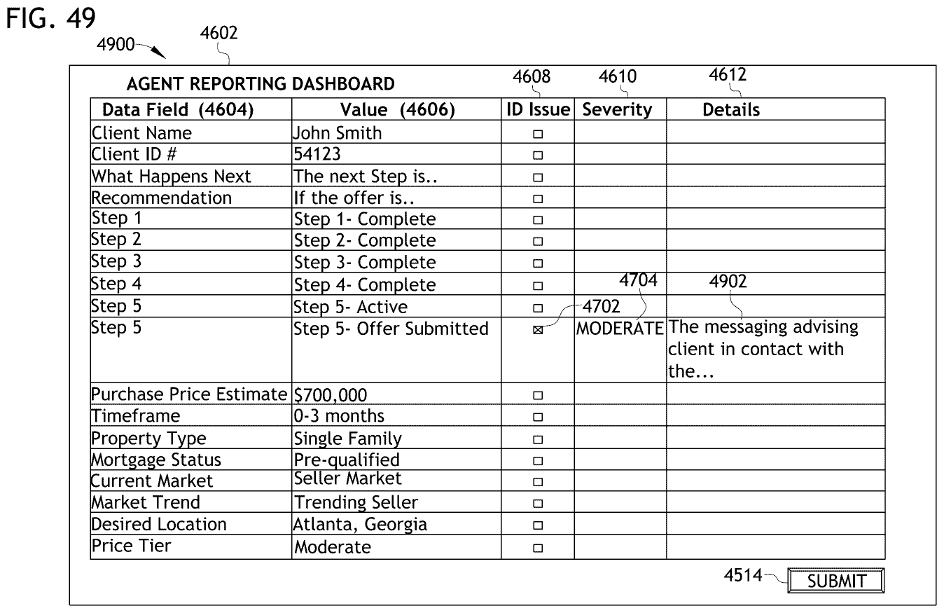

FIG. 49 illustrates the agent reporting user interface 4900 of FIGS. 46-48 wherein the agent user has input freeform details corresponding to a data field and value they would like to report (4702, 4704, 4902) and subsequently selects a submission interface element to submit the report information to the system administrator 4514 (arrow).

### Client Agent Reporting User Interface: System Administrator Report User Interface

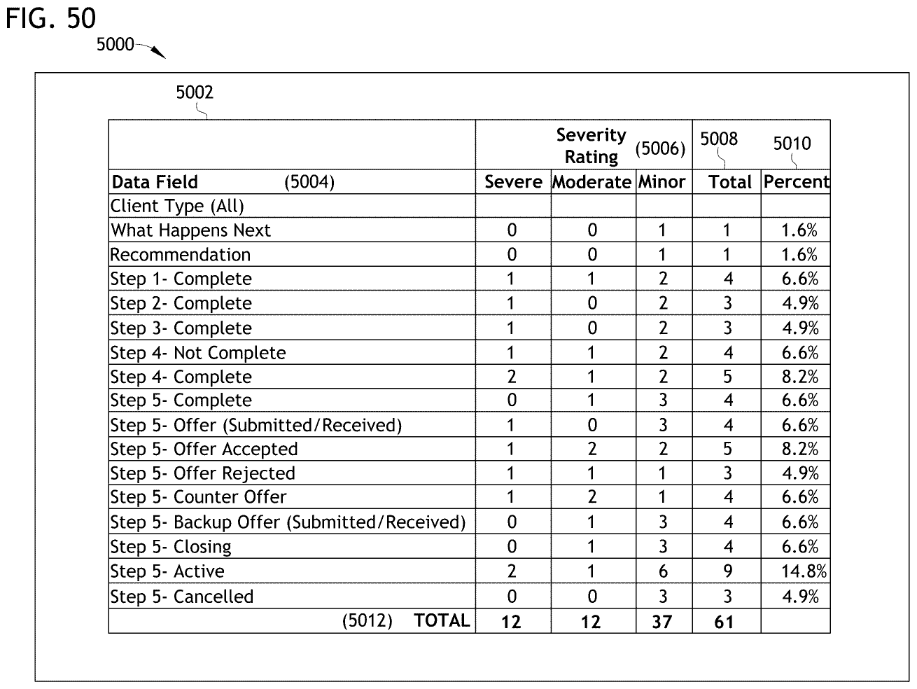

FIG. 50 illustrates a system administrator report user interface 5000 that presents an accumulation of agent feedback for all data fields 5004 in the agent and corresponding buyer client and seller user interfaces.

### Computer System

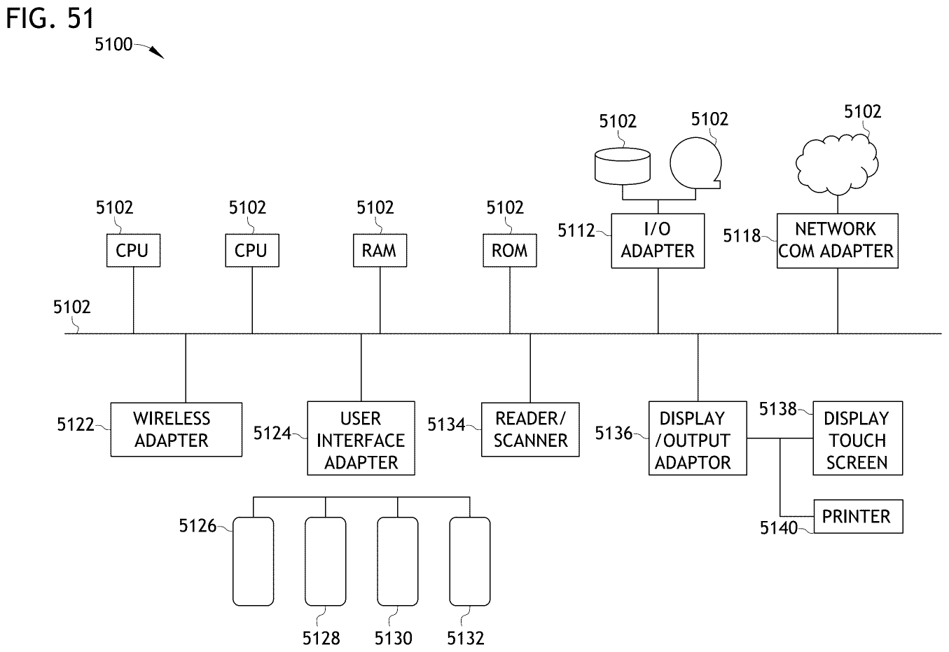

FIG. 51 illustrates an exemplary computer system 5100 configured to support any of the system computational servers of FIG. 1 to enable the methods of the embodiments disclosed herein. Components include a first CPU 5102, a second CPU 5104, RAM 5108, ROM 5110, an I/O Adapter 5112, a Network COM Adapter 5118, a Display/Output Adapter 5136, a Reader/Scanner 5134, a User Interface Adapter 5124, and a Wireless Adapter 5122.

### Exemplary Buyer's Experience

In certain embodiments of this invention, a buyer's experience with the systems and methods of this invention will go far beyond providing a buyer with simply listing information. Instead, the buyer will also obtain valuable directions in navigating the path to owning real estate. The buyer starts by entering in information (e.g., FIG. 5; open-access engagement tool without contact information; anonymized data tracking code). The embodiments of this invention then align the information with market trends and other important facts and presents the buyer with their personalized dashboard (e.g., FIG. 14). That dashboard will contain “What Happens Next”, “Recommendation” and “Reports” sections, in certain embodiments, that will provide the buyer with personalized and relevant directions (e.g., blue prints, roadmaps) on the real estate transaction process and the particular stage the buyer is in. This builds trust, confidence, clarity, accuracy, and competency in the process. An “Expert Tips” section (e.g., explaining mortgage pre-qualified vs. preapproved; explaining bid success; explaining a preapproval letter; explaining credit challenges) is also provided on the “Reports” section of the dashboard, as well as “Tailored (or Additional) Services” (e.g., loans, appraisers, inspectors, movers) and “Insights” (e.g., guidance).

Other parts of the buyer dashboard include “Your Home Search” and recommendations, and market trend information (e.g., trending sellers, trending buyers). The buyer dashboard will also set forth the step in the process the transaction is in.

### Exemplary Seller's Experience

In certain embodiments of this invention, a seller's experience with the systems and methods of this invention provide the seller with valuable directions in navigating the path to selling their real estate. The seller starts by entering in information (e.g., FIG. 5). The embodiments of this invention then align the information with market trends and other important facts and presents the seller with their personalized dashboard (e.g., FIG. 15). That dashboard will contain “What Happens Next”, “Recommendation” and “Reports” sections, in certain embodiments, that will provide the seller with personalized and relevant directions (e.g., blue prints, roadmaps) on the real estate transaction process and the particular stage the seller is in. This builds trust, confidence, clarity, accuracy, and competency in the process. The seller dashboard will also set forth the step in the process the transaction is in.

### Particular Applications to Computer Devices

The system applied to this invention may include a plurality of different computing device types (e.g., FIG. 51). In general, a computing device type may be a computer system or computer server. The computing device may be described in the general context of computer system executable instructions, such as program segments and/or modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to flowcharts and block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

We claim:

1. A method for creating, storing and retrieving a message record configured to be distributed to a client and an agent of the client over a course of a real estate transaction of the client, the method comprising:
(a) providing a system application server including a memory for storing processor instructions and a processor for executing the processor instructions;
(b) providing a system session server, in communication with the system application server, the system session server configured to establish and maintain a system session with and generate a message creation interface accessible by a message creator;
(c) providing a user profile database, in communication with the system application server, the user profile database including a client profile record of the client, the client profile record of the client comprising open-access engagement tools and an anonymized data tracking code;
(d) providing a message database in communication with the system application server, the message database configured to store and retrieve a plurality of stored message records;
(e) receiving message creator input via the message creation interface, the message creator input including: a message identifier, a message title, a client type value, at least one state value, at least one step of a plurality of progressive steps in a real estate transaction of the client, message core data, a message topic description, a target message destination section configured to be displayed on at least one user interface having a plurality of message destination sections, a client agent specific message configured to be displayed on a client agent user interface in a client agent specific message section, a message expiration date, a message specific sort order number value configured to enable sorting of a plurality of message records according to each message specific sort order number, property information regarding the real estate transaction, at least one additional client solicited service information, a current market rating value, a current market trend value, a client specialty value, and a message record update date and timestamp value;
(f) storing the message creator input in a message record within the message database; and
(g) retrieving the message record from the message database based on a user profile record update in response to a change in a step value of the plurality of progressive steps in the real estate transaction of the client in the client profile record and matching at least one message creator input value to at least one data field in the client profile record.

2. The method of claim 1, wherein the client type value is a client buyer value.

3. The method of claim 1, inputting, via the message creation interface, a client buyer mortgage status value.

4. The method of claim 3, wherein the client buyer mortgage status value includes one of a cash buyer status value, a pre-approved status value, a pre-qualified status value, an awaiting status value, and a not applied status value.

5. The method of claim 1, wherein the client type value is a client seller value.

6. The method of claim 1, wherein the at least one step includes one of first step, a second step, a third step, a fourth step and a fifth step in the real estate transaction of the client.

7. The method of claim 6, wherein the first step is configured to notify the client of a status of an initial client information intake process in the real estate transaction.

8. The method of claim 6, wherein the second step is configured to notify the client of a status of completion of an initial client information intake process and an initiation of a client agent matching step in the real estate transaction.

9. The method of claim 6, wherein the third step is configured to notify the client of a status of completion of a client agent matching process and prompt the client for input regarding a proposed client agent.

10. The method of claim 6, wherein the fourth step is configured to solicit client input regarding a proposed client agent and notify the client of a client agent match status.

11. The method of claim 6, wherein the fifth step is configured to notify the client of a particular stage value of a plurality of stages in the real estate transaction.

12. The method of claim 1, wherein the particular stage value of the plurality of stages in the real estate transaction includes at least one of an offer submitted value, a backup offer submitted value, an offer rejected value, an offer rejection value, a counteroffer submitted value, a counteroffer received value, and an accepted offer value.

13. The method of claim 1, wherein message core data includes text information.

14. The method of claim 1, wherein message core data includes a predetermined document having a preconfigured format.

15. The method of claim 1, wherein the at least one user interface includes a client user interface of the client in the real estate transaction.

16. The method of claim 1, wherein the at least one user interface includes a client agent user interface of a client agent assisting the client in the real estate transaction.

17. The method of claim 1, wherein the at least one user interface includes a client user interface of the client in the real estate transaction and a client agent user interface of a client agent assisting the client in the real estate transaction.

18. The method of claim 1, wherein property information includes a property type value including one of a single-family property type, a townhouse property type, a condominium property type, a foreclosure property type, a short sale property type, a probate property type, a bankruptcy property type.

19. The method of claim 1, wherein property information includes a price tier value including one of an affordable price tier value, a moderate price tier value, and a luxury price tier value.

20. The method of claim 1, wherein the at least one additional client solicited service information includes at least one of: a client mortgage service identifier and corresponding client status indicator, a client closing service identifier and corresponding client status indicator, a client moving service identifier and corresponding client status indicator, a client insurance service identifier and corresponding client status indicator, or a client renovation service identifier and corresponding client status indicator.

21. The method of claim 20, wherein each of the corresponding client status indicators include one a client value or a non-client value.

22. The method of claim 1, wherein the current market rating value includes one of a seller strong rating value, a seller balanced rating value, a seller weak rating value, a trending seller rating value, a balanced rating value, a trending buyer rating value, a buyer weak rating value, a buyer balanced rating value and a buyer strong rating value.

23. The method of claim 1, wherein the current market trend value includes one of a seller's market value, a balanced market value and a buyer's market value.

24. The method of claim 1, wherein the client specialty value includes at least one of a veteran buyer value, a first-time buyer value, an investor buyer value, a vacation property buyer value, a retiree buyer value, a court ordered seller value, a trustee seller value, a short sale seller value, and an investor seller value.

25. A method for creating, storing and retrieving a message record configured to be distributed to a client and an agent of the client over a course of a real estate transaction of the client, the method comprising:
(a) providing a system application server including a memory for storing processor instructions and a processor for executing the processor instructions;
(b) providing a system session server, in communication with the system application server, the system session server configured to establish and maintain a system session with and generate a message creation interface accessible by a message creator;
(c) providing a user profile database, in communication with the system application server, the user profile database including a client profile record of the client, the client profile record of the client comprising open-access engagement tools and an anonymized data tracking code;
(d) providing a message database in communication with the system application server, the message database configured to store and retrieve a plurality of stored message records;
(e) receiving message creator input via the message creation interface, the message creator input including: at least one step of a plurality of progressive steps in a real estate transaction of the client, a target message destination section configured to be displayed on at least one user interface having a plurality of message destination sections, a client agent specific message configured to be displayed on a client agent user interface in a client agent specific message section, and a message record update date and timestamp value;
(f) storing the message creator input in a message record within the message database; and
(g) retrieving the message record from the message database based on a user profile record update in response to a change in a step value of the plurality of progressive steps in the real estate transaction of the client in the client profile record and matching at least one message creator input value to at least one data field in the client profile record.

26. A method for creating and storing a message record configured to be distributed to a client and an agent of the client over a course of a real estate transaction of the client, the method comprising:
(a) providing a system application server including a memory for storing processor instructions and a processor for executing the processor instructions;
(b) providing a system session server, in communication with the system application server, the system session server configured to establish and maintain a system session with and generate a message creation interface accessible by a message creator;
(c) providing a user profile database, in communication with the system application server, the user profile database including a client profile record of the client, the client profile record of the client comprising open-access engagement tools and an anonymized data tracking code;
(d) providing a message database in communication with the system application server, the message database configured to store and retrieve a plurality of stored message records;
(e) receiving message creator input via the message creation interface, the message creator input including at least one step of a plurality of progressive steps in a real estate transaction of the client;
(f) storing the message creator input in a message record within the message database; and
(g) retrieving the message record from the message database based on a user profile record update in response to a change in a step value of the plurality of progressive steps in the real estate transaction of the client in the client profile record and matching at least one message creator input value to at least one data field in the client profile record.
